(19) United States
(12) Patent Application Publication
(10) Pub. No.: US 2008/0155019 A1
(43) Pub. Date: Jun. 26, 2008

(54) SYSTEM, APPARATUS AND METHOD TO FACILITATE INTERACTIONS BETWEEN REAL WORLD AND PROPRIETARY ENVIRONMENTS

(76) Inventors: Andrew Wallace, Bellevue, WA (US); David A.W. Snelling, Kirkland, WA (US); Anatole B. Chen, Mercer Island, WA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/955,269

(22) Filed: Dec. 12, 2007

Related U.S. Application Data
(60) Provisional application No. 60/871,030, filed on Dec. 20, 2006.
(60) Provisional application No. 60/982,370, filed on Oct. 24, 2007.

(51) Int. Cl. G06F 15/16

(52) U.S. Cl. 709/204

(57) ABSTRACT

A system, apparatus, and method for enabling communications, commerce transactions, and other forms of interaction between participants in a gaming or other form of virtual environment and the real world, or between a participant in one virtual environment and a participant in a second virtual environment. These and other types of interactions are enabled with a sufficient degree of trust between the participants to encourage such interactions, while at the same time not compromising certain desired characteristics of the gaming or other experience, such as immersion in the experience and the ability to maintain a high degree of anonymity.

### CROSS-REFERENCES TO RELATED APPLICATIONS

The present application claims benefit to U.S. Provisional Patent Application No. 60/871,030, filed Dec. 20, 2006, the complete disclosure of which is incorporated herein by reference. The present application also claims the benefit of U.S. Provisional Patent Application No. 60/982,370, filed Oct. 24, 2007, the complete disclosure of which is incorporated herein by reference.

### TECHNICAL FIELD

The present invention relates to systems, apparatus and associated methods for enabling commerce, communications, and other types of interactions between participants in proprietary environments such as those found in on-line games, simulations and virtual communities, and more specifically, to an identity and reputation management system to facilitate such interactions while maintaining anonymity and other desirable characteristics of participants' experience in a proprietary environment.

### BACKGROUND

Computer and video gaming, and participation in virtual on-line communities have grown to be a popular leisure activity as well as a significant source of revenue for software and game companies. The popularity of such games and virtual communities, and the development of new technologies has naturally resulted in efforts to extend those types of experiences to other platforms (e.g., mobile phones, PDAs, television sets, etc.) as well as to the development of different types of gaming or interactive experiences. One of the newer types of gaming experiences is that termed Massively Multiplayer Online games (or MMOs), also know as Massively Multiplayer Online Role Playing games (MMORPG). This type of gaming experience has developed in response to the availability of Internet connectivity and broadband access to the Internet.

In a typical MMO, a large number of players participate in the same gaming environment (or parallel versions of the same game) using the Internet or another suitable network to provide connectivity. The result is a real-time (or pseudo real-time) gaming experience involving multiple players who may act as individuals or be part of a team. MMOs may have between thousands and millions of players, each of whom typically pays a fee to participate, often in the form of a monthly subscription fee, by consenting (often by default) to viewing advertising material, or by agreeing to purchase items for use in the game. The games are often characterized by the creation of, and interaction with, an imaginary world or environment in which characters interact with each other and with other aspects of the environment. The imaginary world or environment may include landscapes of imaginary worlds, other creatures, weapons, tools, weather systems, forces or powers that act in the world, etc. In many gaming environments, players take on new identities (sometimes referred to as characters, avatars or personas) and use those identities or personalities as the basis for interacting with other players and the environment.

Variations on these types of games include Alternate Reality Games (ARG) and meta-games. These are games which create a world that blends online and real world experiences. For example, a detective style game might include clues found in an MMO, and clues found at a physical location. These games may be authored informally by experienced players rather than larger institutions, yet they still share many of the same characteristics.

Among other characteristics, participation in the games and virtual or simulated environments is immersive and time consuming. The popularity of the gaming and virtual community experience has resulted in a desire on the part of some players to participate in activities beyond the game or community itself. As such, a number of services and products have been developed to support this out of game/community participation, and such services or products are generically referred to as the “secondary market”. Examples of such ancillary products and services available as parts of the secondary market include:

Forums, where players discuss their gaming or community experiences;

Video & photo libraries, where players document their achievements in the gaming or other virtual environment;

Blogs or other forms of commentary devoted to games and the gaming experience or to other aspects of a proprietary environment;

Products to support game play, such as specialized keyboards; and

Markets, where goods and services from within the games or virtual environment may be traded for real currency or other tokens (such as in-game currency or points, etc.).

As will be described, the inventors of the present invention have studied the secondary market and have developed a set of systems and processes to overcome several factors and obstacles currently preventing the secondary market from reaching its potential. Overcoming these factors and obstacles is expected to result in enabling and/or facilitating interactions between players, such as commerce, messaging, social networking, and content exchange, among other beneficial and desired interactions.

As suggested by the development of a variety of ancillary products and services, the popularity of MMOs and other forms of interactive gaming has led to the creation of a market for goods and services to be used with or within games. Further, some aspects of these products and services may exist and be obtained in (or facilitated by interactions with) the “real world”, that is in the physical world outside of the gaming or virtual environment. In addition, some MMOs and on-line communities have their own economies where commerce transactions may be facilitated, e.g., goods obtained within the proprietary environment can be traded or exchanged in order to support certain activities. For example, a participant may need some particular weapon for their avatar in order to complete a task within the game or be able to move on to a more advanced level of the game. In some cases, the weapon may be purchased from a vendor or other player in the game in exchange for in-game currency. The in-game currency may come from completing a task or challenge, demonstrating a specific skill or level of achievement, or another economic activity. Note that while currency is used as an example, trades can also be an exchange of non-currency goods, such as a transfer of skills, knowledge, game earned credits, or accumulated abilities.

Generating sufficient game currency or credits to obtain certain items or skills can be a time consuming activity. In response, a market has developed which matches people who have the time or ability to obtain in-game currency with people who are prepared to expend real world currency to make up for the lack of time they can devote, and yet seek to improve their enjoyment of the game environment. Further, some services—such as help in a particular task, or information needed to accomplish a task—can be just as valuable and tradable as goods (such as weapons, powers, tools, etc.) or game credits. In general, such a market facilitates transactions in which an item, information, or other commodity of value in one environment (e.g., a proprietary gaming environment or world) is exchanged for something of value in another environment (e.g., money in the real world). This is an example of an ancillary product or service in which aspects of either the product or service, or of the process of negotiating for and fulfilling a request for the product or service, may require activities that occur in both the real world and in a gaming or other proprietary environment.

As noted, a typical example of an activity or interaction that may involve both the real world and a proprietary environment is one in which a person desires to purchase in-game currency or credits from another game participant. Such a transaction may require communication of an interest in the purchase from a real world identity through their associated in-game identity to a second in-game identity (and as a result to that identity's associated real world identity), followed by negotiations for the purchase price and delivery terms, and eventually the transfer of real world money to an account belonging to the real world person who is associated with the second in-game identity (who is in possession of the in-game currency or credits). At each stage communications may need to flow between in-game characters and between an in-game character and the real world person in control of that character. In addition, game credits may need to be transferred from one in-game character to another, and real world currency may need to be transferred from one real world person to another. However, as will be discussed, it is desirable that both the communications and transfers be done without interrupting certain desirable aspects of the experience of the game players or user of a proprietary environment, including retaining a desired degree of anonymity by not disclosing the connection between an in-game character and the real world person associated with that character.

As indicated by the discussion of ancillary products and services, there are certain functions, features, and activities which those participating in a gaming environment or other form of virtual environment may desire to have available as part of the gaming or other experience. These include communications (e.g., messaging), social networking, commerce transactions, interactions with other players, the ability to co-ordinate the accomplishment of certain tasks, and other beneficial activities. However, optimally and safely performing these activities often requires interacting or fulfilling obligations in both the virtual (e.g., gaming) environment and the real world, or exchanging information between them.

It is desirable that communications (messaging, data transfer, etc.) across or between worlds, or the execution of a transaction or other form of interaction between the real world and a gaming or other form of virtual environment should have the same qualities that encourage forms of communication or transactions within the real world. That is, it should have sufficient indicia of the trustworthiness of the participants to encourage the interactions, or at the least, not discourage such interactions. These indicia generally relate to the ability to authenticate the participants to a transaction and to prevent repudiation of obligations that arise during a transaction.

However, the desire to develop a sufficient degree of trust between participants within a gaming or other form of virtual environment is made more difficult by the participants' desire to maintain certain aspects of the environment and experience—namely, immersion in the gaming or other experience, minimal interruptions to the experience, and a high degree of anonymity (where here anonymity typically means that the connection between a proprietary environment character and the real world person in control of that character is not disclosed or discoverable). A problem is that certain of these desired characteristics or aspects of the gaming or other experience act to frustrate the ability to generate and maintain a sufficient degree of trust between participants in the experience, particularly when the desired interaction involves the transfer of actual real-world currency between the participants.

What is desired is a system, apparatus, and method to enable communications, commerce transactions, and other desired forms of interaction between participants in a gaming or other virtual environment and the real-world without compromising the desired characteristics of the environment and while achieving a sufficient level of security, authentication, and trust between the participants.

### SUMMARY

The present invention is directed to a system, apparatus, and method for enabling communications, commerce transactions, and other forms of interaction between participants in a gaming or other form of virtual environment and the real world, or between a participant in one virtual environment and a participant in a second virtual environment (typically using a connection to the real world as an intermediary stage of the transaction). The invention enables these and other types of interactions to occur with a sufficient degree of trust between the participants to encourage such interactions, while at the same time not compromising certain desired characteristics of the gaming or other experience, such as immersion in the experience and the ability to maintain a high degree of anonymity.

The present invention provides a system architecture that enables the provision of an identity management and verification service for participants in a proprietary environment. The inventive functions and services may be used as a bridge or gateway that couples the real world and one or more proprietary environments, thereby enabling a transfer of data between the real world and the proprietary environments. The inventive functions and services may be used to create a proprietary world identity, assert a claim of ownership over an identity, challenge another's claim of ownership over an identity, and execute certain processes involved in authenticating an ownership claim to an identity. The inventive functions and services may be performed without compromising a participant's desire for anonymity or creating a discoverable connection between a real world person and the proprietary environment character or persona that they control.

In some embodiments, the present invention may be implemented as part of a client-server architecture in which certain of the inventive system and functions are hosted on a server (e.g., a bridge or gateway server) that is in communication with one or more client devices or processes over a communications network. The client processes or functions may be embodied as software applications executing on a client device operated by a user of the inventive system. The user is in communication with both the bridge or gateway server and with a server hosting an instance of a proprietary world or environment. The bridge or gateway server hosts processes, applications, software instructions, or other suitable forms of implementing aspects of the invention that enable a user to manage the avatars associated with the user and participate in a process to verify the ownership of an avatar by either the user or another participant in a proprietary environment.

In some embodiments, the present invention is directed to an apparatus to verify that a first participant in a proprietary environment is the owner of a proprietary world identity, where the apparatus includes a data storage medium including a set of instructions, a processing element configured to execute the set of instructions, which when executed cause the processing element to implement processes that include enabling selection of the proprietary world identity by the first participant in the proprietary environment, generating first identity verification data, storing the first identity verification data, providing the first identity verification data to a second participant in the proprietary environment, receiving second identity verification data from the first participant in the proprietary environment, comparing the first identity verification data to the second identity verification data, and verifying ownership of the proprietary world identity selected by the first participant if the first identity verification data and the second identity verification data are substantially equivalent.

In another embodiment, the present invention is directed to a method of verifying that a first real world person is an owner of a first proprietary world identity, where the method includes determining a second real world person having a previously verified proprietary world identity, generating first identity verification data, providing the first identity verification data to the second real world person, receiving second identity verification data from the first real world person, comparing the first identity verification data with the second identity verification data and if the first identity verification data and the second identity verification data are substantially equivalent, then verifying that the first real world person is the owner of the first proprietary world identity.

In yet another embodiment, the present invention is directed to a method of enabling a first real world person represented by a first proprietary world identity to engage in an interaction with a second real world person represented by a second proprietary world identity, where the method includes registering one or more proprietary world identities associated with the first real world person, verifying that the first real world person is the owner of each of the one or more proprietary world identities, presenting the first real world person with a list of the one or more proprietary world identities that the first real world person is the verified owner of, receiving from the first real world person a selection of one of the one or more verified proprietary world identities, and utilizing the selected verified proprietary world identity to interact with the second proprietary world identity.

In yet another embodiment, the present invention is directed to a system to facilitate interactions between a first participant in a proprietary environment and a second participant in a proprietary environment, where the system includes a server in communication with and capable of exchanging data with a first client and a second client, the first client operated by the first participant and the second client operated by the second participant, a process executing on the server to enable the first participant to select a proprietary environment identity, a process executing on the server to enable the second participant to select a proprietary environment identity, and a process executing on the server to enable verification of the ownership of the proprietary world identity selected by the first participant.

These and other advantages of the invention will be apparent to those of ordinary skill in the art by reference to the following detailed description and the accompanying drawings.

### BRIEF DESCRIPTION OF THE DRAWINGS

FIG. 1 is a functional block diagram illustrating the primary functional elements or structures of one form of a cross-world commerce interaction or transaction;

FIG. 2(a) illustrates a conceptual embodiment of the inventive cross-world bridge which may be used to enable interactions and transfer data between the open world and a proprietary world;

FIG. 2(b) is a functional block diagram illustrating the primary functional elements or structures of one form of a cross-world commerce interaction or transaction that includes use of an embodiment of the inventive bridge or gateway;

FIG. 2(c) is a diagram illustrating the functional processes and messages exchanged to verify the ownership of an avatar in a proprietary world in some embodiments of the present invention;

FIG. 3 is a functional block diagram illustrating the primary functional elements of an embodiment of the inventive Identity Bridge of the present invention;

FIG. 4 is a functional block diagram illustrating the primary functional components of one embodiment of the inventive system;

FIG. 5 is a flowchart illustrating an exemplary process for the operation of a user driven interface for managing a user's identity in some embodiments of the present invention;

FIG. 6 is a flowchart illustrating an exemplary process for enabling a user to claim or create a character or avatar for use in a proprietary environment in some embodiments of the present invention;

FIG. 7 is a flowchart illustrating an exemplary process for enabling a user to challenge an assertion by another of ownership or control of a character or avatar for use in a proprietary environment in some embodiments of the present invention;

FIG. 8(a) is a flowchart illustrating an exemplary process for enabling a user to verify a claim by another of the control of a character or avatar for use in a proprietary environment in some embodiments of the present invention;

FIG. 8(b) is a flowchart illustrating an exemplary process for obtaining an appropriate verification or other task for a community member to perform in some embodiments of the present invention;

FIG. 8(c) is a flowchart illustrating an exemplary process for evaluating a proposed task to determine if it is suitable for execution by a community member in some embodiments of the present invention;

FIG. 9(a) is a flowchart illustrating an exemplary process for verifying a key or other security or authentication data for asserting a claim of ownership for a character in some embodiments of the present invention;

FIG. 9(b) is a flowchart illustrating an exemplary process for testing whether the claim key is valid by determining if the user entering the key is also the user who made the original assertion of ownership of the character;

FIG. 9(c) is a flowchart illustrating an exemplary process for executing a challenge process to the claimed ownership of a character or avatar;

FIG. 9(d) is a flowchart illustrating an exemplary process for enabling a participant in a verification process to provide feedback and a rating on their experience with the community member involved in the verification process or task;

FIG. 10 is a flowchart illustrating an exemplary process for enabling a user to release an assertion of ownership in some embodiments of the present invention;

FIG. 11 is a flowchart illustrating an exemplary process for enabling certain housekeeping or cleanup tasks such as removing verification tasks that do not seem to be successfully executing from the queue in some embodiments of the present invention;

FIG. 12 is a functional block diagram illustrating the key components of an Identity Cluster system in some embodiments of the present invention; and

FIG. 13 is a functional block diagram illustrating the key components of an implementation of a peer verified metadata function in some embodiments of the present invention.

### DETAILED DESCRIPTION OF EXEMPLARY EMBODIMENTS

Prior to describing the present invention and certain of its embodiments in greater detail, it is helpful to introduce one of the underlying concepts that will be discussed and which is important to understanding the context of the invention. This concept is that of a gaming environment, virtual environment, or other form of “proprietary world” and the physical, external world, which is a form of the “real” or “open” world.

As will be discussed, the present invention relates to “worlds” or environments” in which real people or representatives of real people (such as personas, owned or controlled characters, avatars, etc.) interact. A world may be considered to be an environment of rules and laws in which people participate either as themselves, or as an entity that represents themselves. Such worlds are generally self-contained and may operate independently of interactions with other worlds. Typically, participants in a world may engage in certain types of interactions, such as:
communications with other participants in the world;
an exchange of goods with other participants in the world;
the performance of services for other participants in the world;
providing rewards to and receiving rewards from other participants in the world; and
participating in and/or receiving rewards from the managers/operators of the world.
   Note that the above list is intended to be illustrative, rather than exhaustive. A world may include a variety of systems to enable or enhance some or all of these activities, such as, but not limited to, email or other communications systems, auction houses, banking or investment systems, etc.

The present invention generally relates to enabling or facilitating interactions within and between two kinds of worlds; a closed or proprietary world (e.g., a gaming environment, simulation, on-line community, or other form of virtual environment) and the open world (e.g., the real or physical world). These two types of worlds may be described in general terms in the following manner:
Proprietary World: a world or environment created, owned and typically operated by an entity such as a corporation, association, cooperative, institution, organization or individual. The entity is typically responsible for creating, modifying, and policing the rules, regulations and laws governing participation in that world. An example would be the virtual world or environment created for a computer game in which game players participate. Another example would be a virtual world created to mimic the real world, such as a simulated environment or society; and
Open (Real or Physical) World: a world where corporations, institutions, organizations and individuals participate and interact amongst each other. Such a world cannot be owned by those entities. Generally, the government of a country (e.g., as recognized by the United Nations) is responsible for creating, modifying and policing the rules, regulations, and laws that govern interactions between participants in this world. A corporation or institution may define additional rules and regulations that apply to its own internal and external interactions, but these are subordinate to the rules and regulations of the governmental entity. An example would be the “real” or physical world in which people participate in interactions with each other and with institutions such as banks, businesses, etc.

Note that one distinguishing feature of Proprietary and Open worlds is that Proprietary worlds may be turned off, or suspended, (although the managing entity may prefer to avoid such events), while an Open world cannot be turned off. Further, in an open or real world, people typically interact using their own identity (that is, unless they are pursuing an illegal or otherwise unpopular activity), which is verifiable by accessing certain governmental organizations (such as the police, social security office, etc.).

As will be discussed, the present invention is directed to systems, architectures, apparatus, and methods for implementing services, functions, and features that enable or facilitate interactions between two participants in a gaming or other from of virtual environment. In some embodiments, the interaction will be between a first person in the real world (who is represented by an avatar or similar construct in a virtual environment) and a second person in the real world (who is represented by a second avatar or similar construct in the same virtual environment), where the direct communications will be between the participants' avatars instead of the actual physical people represented by those avatars. Further, although the present invention will generally be described with reference to enabling interactions between participants in the same gaming or virtual environment, the interactions may be between a participant in a first gaming or virtual environment and a participant in a second gaming or virtual environment, or between a participant in a gaming or virtual environment and a second participant acting in the real or physical world (and hence represented by their own, actual identity). Note that in the case of an interaction between participants in the same or different gaming or virtual environments the invention may be used as an intermediary element that couples each proprietary environment to the real world, and hence to each other. Note further that when acting in a gaming or virtual environment the participant will generally be represented by a fictitious persona or character that they have created and/or become associated with.

The communication, transaction or interaction itself may take place wholly or partially within a gaming or virtual environment, between one or more gaming or virtual environments, or between a gaming or virtual environment and the external real world. The communication, transaction, or interaction may involve messaging (email, instant messaging, etc.), blogging, a transfer of images or video, or other form of communication, a commerce transaction, a sequence of actions or tasks, an exchange of information or data, or other form of interaction. The communication, transaction or interaction may involve a transfer of information, credits, or other item of value in the real world or proprietary environment. However, in general, regardless of the type of interaction or nature of the world in which the interaction occurs or in which the participants act, effective and reliable interactions typically depend upon certain characteristics that have been recognized by the inventors.

As recognized by the inventors, a key characteristic of effective and reliable interactions, and a characteristic, which if lacking, acts as a disincentive to continued interactions, is the concept of trust. The trust referred to is typically that between participants to an interaction or transaction, and may be of added importance in situations where the participants are previously unknown to each other and/or new to a particular proprietary environment. The concept of trust becomes of greater importance when the set of environments or worlds is varied in number and the possible combinations of real and proprietary environments increases.

As will be described, the inventive system, architecture, bridge, gateway or other means of coupling and enabling data transfer between proprietary worlds or between a proprietary world and the real world enables participants to create, authenticate, verify, enhance or transfer certain underlying qualities between worlds that enable them to “be trusted” or to achieve a certain “degree of trustworthiness”. These underlying qualities include, but are not limited to, at least three general categories or types of characteristics: (1) Reputation (in its multiple forms); (2) Affiliations (group affiliations/memberships); and (3) Connections (e.g., a way to know or verify that the participant a player interacts with in world A, is the same as the participant they interact with in world B).

The inventors have recognized that several problems need to be resolved and/or obstacles overcome before the gaming or virtual environment and the real world can be coupled or otherwise connected to permit data and information transfer in a manner that is satisfactory to engender a sufficient degree of trust between participants. Some of these problems or obstacles are related to the reason(s) why the proprietary worlds or gaming environments are attractive to participants in the first place. Although some of the game or virtual environment play is close to real life work in its repetitiveness and tediousness, it is pursued with enthusiasm and perceived to be fun. Research conducted by the inventors has led them to believe there are several components to the source of this enthusiasm:
Flow: This is the concept that people can achieve a state of concentration on a task that blocks out other thoughts and enables them to achieve a sense of mastery. Flow can be found among assembly line workers, office workers, sports players, and game players. Participants in proprietary environment activities find the flow to be immersive and extremely rewarding;
Reputation: This is a measure of the recognition that a person achieves for their avatar or representation within a gaming or virtual environment, or other form of community. It may be a reflection of the achievements of that person within the game or environment, and is more valuable when other community participants, or peers, have an appreciation of what those achievements have required or represent in terms of game-playing skills, etc. As such, building a reputation is both valuable and rewarding to the participant; and
Rewards: The prospect of a reward for certain activities, whether challenging or not is motivating to most players, and can be managed by the operators of the gaming environment to encourage intense participation. Rewards may include in-game or in-environment currency, gifts of virtual items, the enabling of additional activities, skills, or powers, and an increase in game reputation, for example.

Participating in cross-world activities (either between open and proprietary worlds, or between different proprietary worlds), such as the secondary market, implicates these characteristics in at least the following ways: (1) the sense of proprietary world flow or in-world involvement is interrupted by the experience of moving to the different user experience of using browsers, finding sites, managing content, etc.; and (2) reputation or other advantageous associations obtained in the gaming or other virtual environment are not transferred to (or associated with) the secondary interactions because there is no verifiable connection between the in-world avatar and the secondary market participant acting as part of the real world.

Another issue relates to the concept of trust. In the absence of laws or enforceable rules, an issue becomes how a participant in one game or environment can relate in a trusting manner to another participant whom they have never met or had an interaction with. In particular, how does one trust a participant in a proposed commercial transaction when that person is, by the nature of the game, hidden behind an identity suitable for that world or environment?

Yet another issue is related to participants' desire for anonymity. Participants in gaming and other forms of virtual environments generally want to keep the relationship between their real world identity and their Proprietary World identity secret. Reasons for this preference may include enhancing the immersive experience and providing security from the behaviors of other proprietary world participants—particularly as some game or virtual environment behaviors are not appropriate open world behaviors.

As the present inventors have also recognized, there are presently no optimal approaches to providing the types of services and functionality desired by many gaming and virtual environment participants, subject to the described constraints and the participants' desire to retain the benefits of immersion, trust, and anonymity. As understood by the inventors, while approaches exist that might arguably be used to provide functionality that is in some ways similar to that of the inventive features or functions, these approaches are incomplete, sub-optimal, or less desirable than the inventive approach, and in general, do not provide the benefits mentioned. For example:
Network Gateways: Network gateways depend on the cooperation of the managers of the systems on both sides of the gateway. If one manager chooses not to participate in the network, the gateway can be switched off and an island created. Further, building the gateway demands knowledge of both systems being connected and this may not be provided or made available, and in the case of multiple networks, a combinatorial explosion develops as each new network attempts connection to all the others;
Global Directories: Global directories are lists of identities composed by managers of systems publishing their directory of identities into the global list. This demands cooperation and willingness of the managers of each system. A variation would be for each individual to publish their own identity to the directory, but the system then depends on the identity being known by some Open World identifier (thereby impacting the desire for anonymity) which is understood or must be verified by all the systems involved;
Online Commerce Systems: Online commerce systems, such as online auctions and online stores depend on passing Open World identity information between participants. This breaks the desire for anonymity. Should an alias be used to preserve anonymity, then it will: a) not be possible to manage the transfer of trust between proprietary worlds (as each new alias is an essentially un-trusted or unverified identity); and b) the desired anonymity will be punctured as part of completing the transaction if the transaction involves crossing a bridge between worlds. While certain commerce systems may conceal certain components of an identity (such as a credit card number) they typically must reveal the general identity in order to establish the correct transaction;
User Messaging Systems: A messaging system can run under a user's control at the same time as the user participates in a Proprietary World. However, there is no real connection between the user's identity in the messaging system and the identity of the user in the Proprietary World. If there is a relationship, it has been created by the user at the expense of anonymity. More likely is that a relationship has been asserted but there is no provision for other participants to verify or authenticate it;
Proprietary Tags: Some Proprietary Worlds are managed by organizations that also have other Proprietary Worlds in their domain. These organizations can connect identities from their Proprietary worlds into larger identities. These larger identities go by various names, such as “Tags” or “Cards”. A limitation of this approach is that even the largest organizations include only a small subset of the full set of possible Proprietary Worlds, thus limiting the extent to which the Proprietary Tags are useful or accepted. Thus, in terms of verifiable identity and the resultant trust it can be used to engender, a participant is limited to the worlds supported by the particular organization. Hence, for the purposes of the present invention, such conglomerated Proprietary Worlds can be viewed as having the same issues as an individual Proprietary World;
Personas: Personas, or aliases, are identities created by a person to show some particular aspects of themselves to (generally) disparate groups of other people. An example might be someone who has a “School” alias for interacting with old school friends, and a “Business” alias for interacting on a professional level. A person may even create a Persona that is unknown by anyone else. Personas as a representation of a person do not, however, address the problem of relating Personas in different Proprietary Worlds while satisfying the desire to retain anonymity and/or providing a mechanism for proof of connectedness between different world personas. Further, it is generally not possible (or at least appropriate) to maintain multiple personas in the same world;
Mapping: mapping systems are similar to directories and suffer the same weaknesses of dependency on system manager cooperation, or user honesty. They may have an advantage over directories as a result of a user interface tuned to the task of mapping identities; and
Email Verification Systems: These are systems commonly deployed on websites to ensure that someone creating an Identity on a website is a real, verifiable entity in the Real World, in the sense that: a) the website can communicate with the person; and b) that the person has genuinely created the Identity. However, these systems are not suitable for bridging the Real World and Proprietary Worlds as defined with regards to the present invention because the email systems used do not cross the Real-Proprietary World boundary. Thus, they cannot be used to verify that the identity of a participant in a Proprietary World is managed or associated with a particular Identity in the Real World.

However, there is a concept recognized by the inventors as providing a possible solution to some or all of the problems encountered in bridging the two types of worlds, and that concept is reputation. A person with a “good” or positive reputation as a seller or participant in an interaction is likely to be more trustworthy (or at least considered by prospective participants in an interaction to be more trustworthy) than a person with a lesser reputation. Part of this situation is due to the interactions that generated the good reputation (and hence demonstrate a history of trustworthiness) and partly because of the desire of the possessor of the good reputation to maintain it. The same principles apply to participants on the other side of an interaction. As a result, for example, a highly regarded seller may be able to charge a higher price, since the risk incurred by the buyer is assumed to be less. In this sense, the seller's reputation has value as a commodity or intangible form of goodwill. Further, since it is valuable, the seller is likely to be more receptive to dealing with any events that may lessen that value—such as an unhappy buyer—further enhancing the desirability of interacting with such a seller.

This type of reputation may be referred to as a form of commercial reputation. However, reputation can be associated with a behavior as well. For example, a reputation for trust indicates trustworthy behavior; a reputation for organization indicates an ability to get groups of people together to complete a task, etc. One interesting and in some circumstances beneficial aspect of reputation is that it is leaky, in the sense that having a good reputation for game play (for example) may lead to an implicitly granted or conferred reputation for organization that may be higher than is otherwise warranted. This further increases the value of a participant's reputation as well as their desire to communicate that reputation to prospective participants in an interaction with the holder of the reputation.

Thus, reputation is an aspect or characteristic associated with a player or proprietary world participant that is valuable to that person. However, players participate in more than one game or virtual environment (sometimes in parallel, meaning two or more games at the same time, and sometimes sequentially, meaning moving from game to game as they are released onto the market), and sometimes may be represented by multiple identities in the same game. And each time the player moves to a new world or virtual environment, the valuable commodity of reputation is set back to zero or to some nominal level, representing a potentially considerable loss in a commercial sense that can only be regained over time and by expending effort.

As the inventors have recognized, participants in on-line gaming and other interactions within a proprietary world, virtual environment, on-line community or similar construct desire to interact in a variety of ways, with certain desired characteristics:

participants desire to be able to interact with multiple proprietary worlds (e.g., different gaming or imaginary environments) and between those worlds and the open or real world;

participants desire to remain anonymous (both with respect to their multiple possible proprietary identities and their open or real world identity); and

participants desire to be able to interact with others in commerce, communications, and social networking transactions, among others, with a sufficient degree of trust to encourage such interactions.

Further, as the inventors have also realized, a participant's reputation provides one way in which other participants can obtain confidence in a party with whom they may desire to conduct a transaction, and hence reputation may act to enable such transactions. And, as the inventors realized, these goals may be achieved by the introduction of the identity management and verification, and transportable global reputation system and methods of the present invention. The inventive system and methods may be introduced into transactions or interactions, and thereby facilitate and/or enable those transactions or interactions between two participants in a proprietary world or between a participant in a proprietary world and one in the real (or open) world.

Having recognized the noted aspects of participation in a gaming or other form of virtual environment, the present inventors have developed, among other things, a solution to the problem of bringing together identities and reputations gained in different worlds (be they open, real, or proprietary) in such a way as to enhance participation in secondary markets. Further, the inventive system provides the additional benefits of supporting a high degree of trust and retaining the sense of flow or immersive experience in the proprietary worlds. Among other aspects, the inventive system, architecture, processes and methods operate to provide participants in proprietary environments with tools to manage their identities and related data, verify another's claim of ownership to an identity, and verify the alleged association between certain characteristics or attributes of an identity and that identity (and hence the accomplishments or qualities of a real world person), thereby enabling a transfer of reputation between worlds or environments. These and other aspects and benefits of the present invention will now be described in greater detail with reference to the indicated figures.

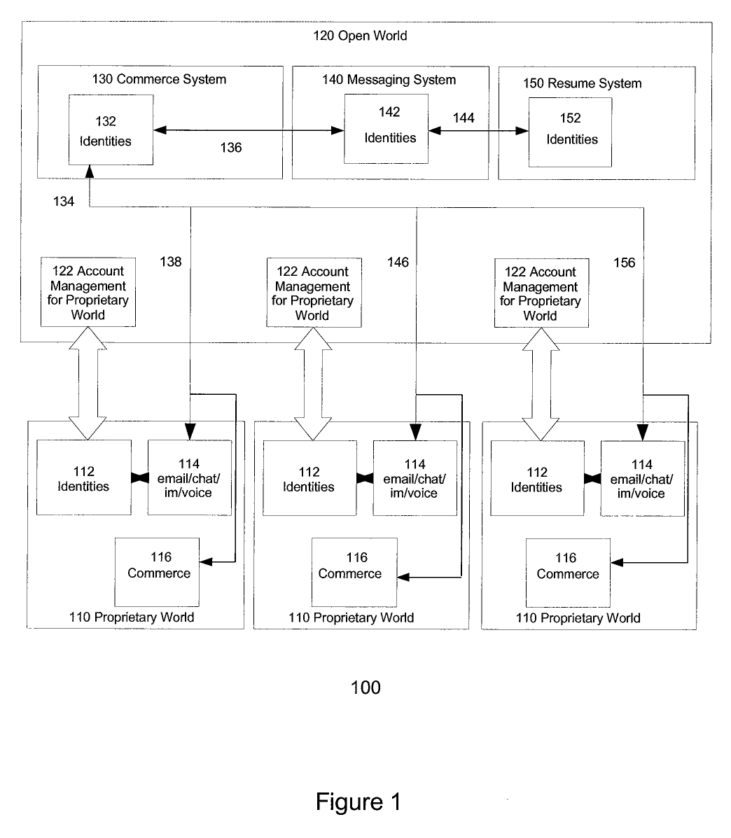

FIG. 1 is a functional block diagram illustrating the primary functional elements or structures of one form of a cross-world commerce interaction or transaction 100. As shown in the figure, two types of “worlds” or environments are involved in the interaction or transaction; the open or real world 120 and one or more proprietary worlds 110. Note that each proprietary world 110 may represent a simulation, on-line world or community, virtual world or gaming environment, for example. Each such proprietary 110 world typically has its own internal system(s) for managing identity (shown as elements 112), communications (shown as elements 114) and commerce (shown as elements 116) within that world or environment. Elements 122 represent account management functions for each respective proprietary world 110. Account management functions 122 are accessible through the open or real world 120, which as noted may represent the physical or actual world that participants reside within. Account management functions 122 may include, but are not limited to, account set-up, user name and password selection, and authentication.

Elements 130, 140, and 150 represent real world commerce 130, communications 140, and resume (referring to a compilation of achievements, ranking, tasks completed, etc., in some sense a form of reputation) systems 150, respectively. Note that such systems are used as examples of types or classes of systems that a person or entity participating in a proprietary environment might interact with as part of a transaction or interaction either within that world or between that world and the real world or another proprietary world. Note further that a user participating in these worlds must create identities (registration and authentication functions such as user name, password, account data) in each of these systems (as indicated by elements 132, 142, and 152), and manage the relationships between those identities and the respective systems, and between those identities and themselves. For example, a user may have a real identity which includes an email account and a commerce account in real world systems, which is manageable. However, the user may also have multiple proprietary world identities, each of which they may wish to also use with their real world email & commerce identities. As the number of such proprietary world identities grows, the management of the relationships can be become onerous and thus sub-optimal.

However, as recognized by the present inventors, to enable a cross-world transaction (e.g., between an open or real world and a proprietary world, or between two proprietary worlds (which may involve using the real world as an intermediary)), a user must manage an exchange of identity or other information between each of these systems and worlds. For purposes of illustration, arrows 136 and 144 show Identity information being shared among the three open world systems being used for this example. For example, concluding a commerce transaction typically requires that information exchange occur within the commerce system, and also that an email message is sent to those exact same identities to indicate conclusion, possibly including a transaction number. Arrows 134 and 138 indicate exchanges of Identity information that may be necessary to complete a commerce transaction that includes a trade occurring in a proprietary world. In this case the Identity information is being used to ensure that (for example) the money being exchanged between two participants in the open world commerce system 130 is matched with a good or service being exchanged between exactly the same two participants in the proprietary world, except for the key difference that each participant is being represented to each other by a proprietary world identity. Arrows 146 and 156 indicate the multiplicative nature of the system as the number of proprietary worlds in which a person is involved increases. Note that each connection or exchange of data will typically be:
1. troublesome to create, since it must first be described to the other party of the transaction; and,
2. involve revealing the Open World and Proprietary World identities of a participant and the relationship of those identities to each other.

The following further discusses some of the problems recognized by the present inventors that have been encountered or represent obstacles to building gateways, links, bridges, or other forms of coupling between Open and Proprietary Worlds, and which therefore constrain the possible solutions and types of interactions:
Identity—a participant may use different names in different worlds. It is therefore impossible to determine whether a part of a transaction happening in one world is with the same participant as in the other world;
Trust—if a participant cannot identify some connection between two identities in different worlds, it is difficult to determine whether to transfer levels of trust or reputation between those identities;
Anonymity—a benefit and desired aspect of participating in Proprietary Worlds that is valued by many participants is that of anonymity. This enables a participant to be someone or something very different in each proprietary world, or in the real world and a proprietary world. However, this form of anonymity cannot be maintained if an Open World identity is used to join or otherwise associate identities in the real world and one or more proprietary worlds. Preferably, an association or link between a real world person and a proprietary world identity should be confidential and not be discoverable;
Immersive Experience—people participating in a Proprietary World often value, and indeed may desire, an immersive experience. However, it is typically not possible to retain a satisfactory level of that experience when engaged in tasks that require interruptions or involve transitions between the Proprietary World and the Real World;
Paired Transactions—cross-world transactions, particularly those involving commerce, are typically composed of two transactions. The participants will complete one transaction in an Open World and a corresponding transaction in a Proprietary World. A cross-world transaction can only be considered to have been successfully completed if both individual transactions are completed successfully. However, since each part of the paired transactions occur in different worlds, it is difficult to achieve or verify this successful completion. If the participants use different aliases in each world, then it becomes substantially more difficult;
Growth—the number of Proprietary Worlds has no restriction and is growing rapidly. It is therefore technically difficult to implement a scalable and reliable solution to bridge all possible worlds or each pair of real and each proprietary worlds in order to keep pace with this growth;
Proprietary Interfaces—typically, a Proprietary World implements its own interface, with some not having programmable interfaces at all—the only interface to such a world is the user interface which is often not suitable as the basis for reliable interaction. This means that building a traditional gateway between the worlds is difficult and a sub-optimal solution;
Value of Accounts—the managers of Proprietary Worlds associate great value with their account information—meaning, for example, the Open (real) World mechanism whereby a participant is identified or authenticated to enable their participation in the Proprietary World. This type of information is valuable for additional commerce and marketing purposes. Also, as noted above, many participants place value in keeping the connection between their Open World and Proprietary Worlds identities unknown (and as recognized by the inventors, may at the same time place value in making a connection between certain of their multiple Proprietary World identities known to those with whom they interact);
Scale—the numbers of participants in Proprietary Worlds may be measured in millions. This means a manual system of connecting participants is not realistic or optimal;
Valuation—the relative worth of a good or service has proven difficult to compare between worlds. In some sense, each Proprietary world can be viewed as running its own economy. The value of some commodity, gold for example, may have no equivalent in the other world, or the different values placed on the commodity by the respective economies may be irreconcilable or immeasurable, and may be changing frequently or continuously;
Willingness—the managers of Proprietary Worlds are not necessarily willing to participate in connecting their Worlds to Open Worlds or to other Proprietary Worlds. The desirability to do so is driven by the participants of the Proprietary Worlds;
Recycling—when a participant ceases to use or own a particular identity, certain worlds will recycle the identifier (i.e., the name) of that identity to another participant. This may lead to confusion and loss of trust in that identity or the system if this change is not communicated to participants;
Transferability—the system should enable and not impede the transfer of Proprietary World identities between real world identities; and
Security—a real world identity should be able to manage which Proprietary World identities are exposed for any particular transaction and to whom they are exposed.

In recognition of, and in response to, the above and other aspects of participation in a proprietary environment, the present inventors have developed a system, apparatus, architecture and methods to support interactions such as messaging and commerce between the Open or Real World and Proprietary Worlds, or between Proprietary Worlds. As will be discussed, among others, important problems solved by the present invention are those of the need for an identity management system and the provision of verifiable identity and transportable reputation functions. Note that as further recognized by the inventors, additional systems, use cases, value propositions, and types of interactions are enabled and/or facilitated by the solving of these and other problems. For example, Alternative Reality Games and Meta-Games (such as cross world games created by participants for other participants) are more readily created using a system which has solved these problems and the experience enriched by enabling use of world appropriate identities. Another example is club or guild membership, which is simplified when an identity management system for multiple worlds is available. Note that the inventive Identity Bridge architecture can be used to facilitate or enable a number of activities and types of interactions, including, but not limited to, commerce, banking, social networking, messaging, content exchange, etc. For purposes of clarity, a representative example activity will be described, that of the commerce transaction described previously with reference to FIG. 1.

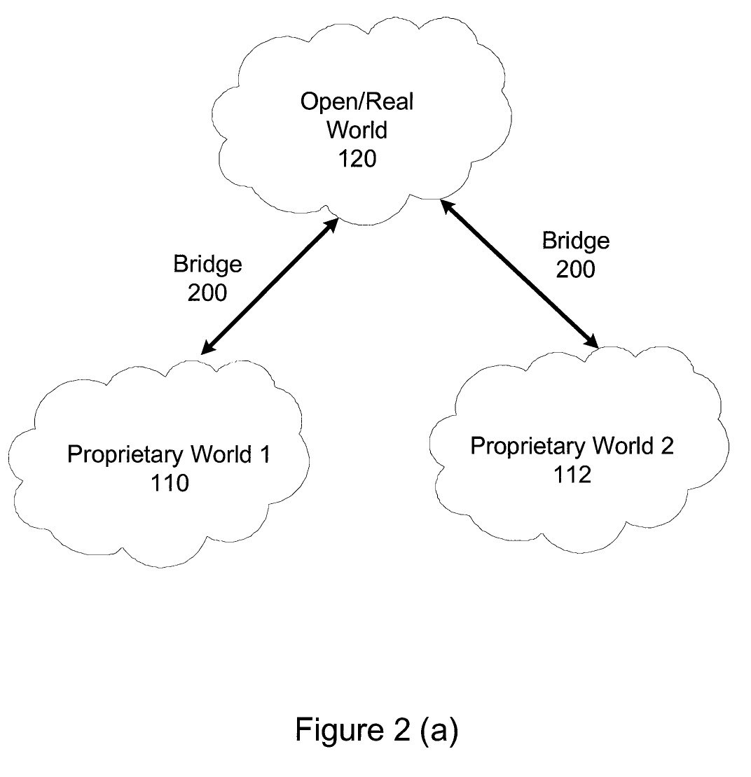

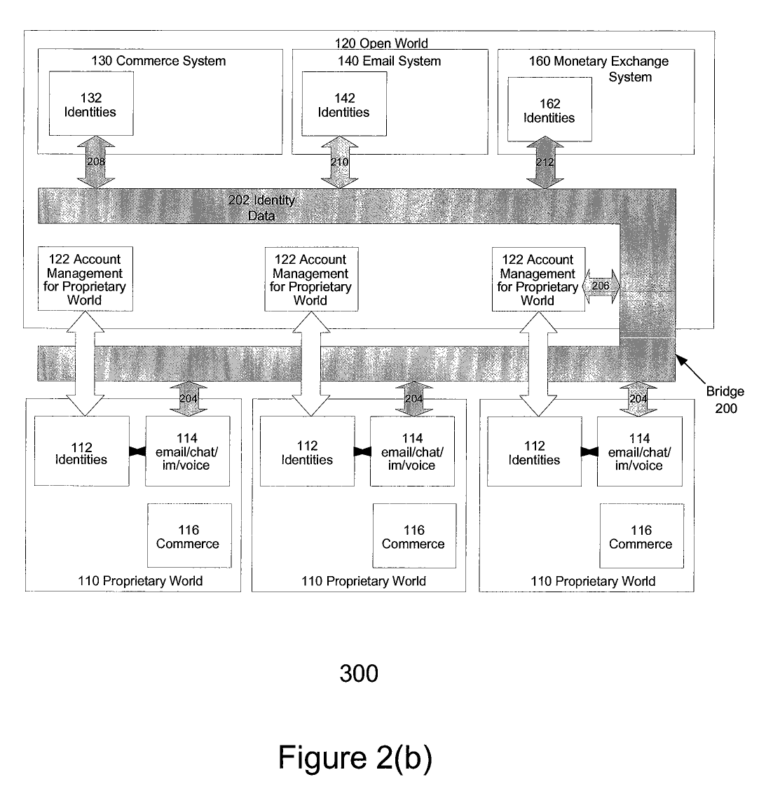

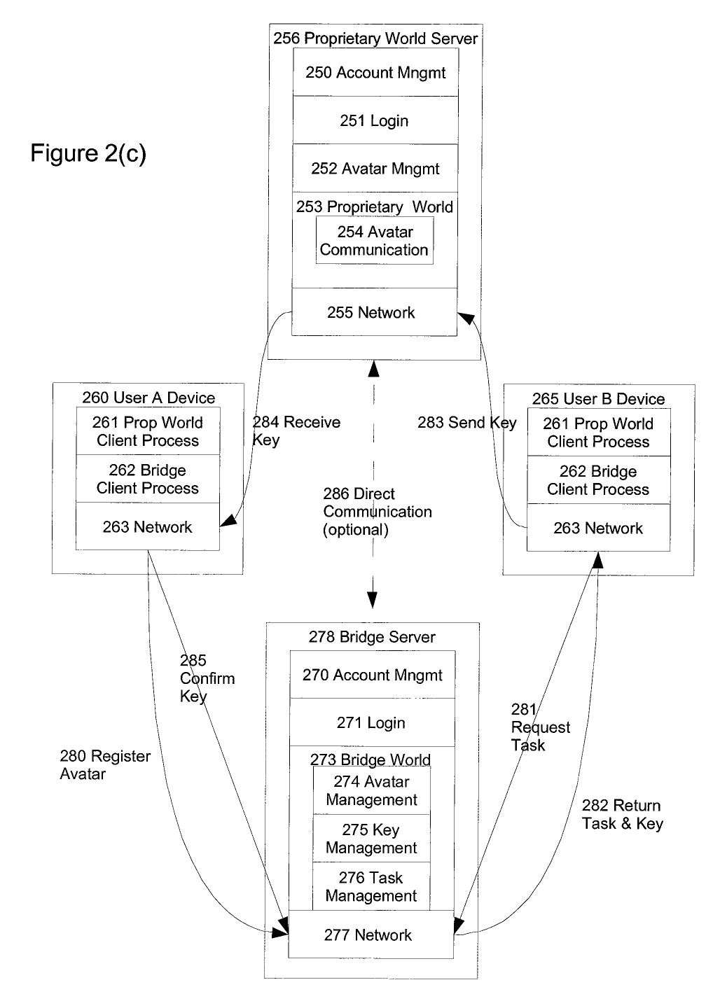

FIG. 2(a) illustrates a conceptual embodiment of the inventive cross-world bridge 200 which may be used to enable interactions and transfer data between the open world 120 and a proprietary world 110 (or between a first and a second proprietary world using the open or real world as an intermediary). As shown in the figure, in some embodiments, bridge 200 functions as a bi-directional data transfer element between real or open world 120 and proprietary world 110 or between real or open world 120 and proprietary world 112, for example. In other embodiments, the transfer may take the form of causing a connection between identities to be created or managed without necessitating any specific form of data transfer.

FIG. 2(b) is a functional block diagram illustrating the primary functional elements or structures of one form of a cross-world commerce interaction or transaction that includes use of an embodiment of the inventive bridge or gateway 200. Note that bridge or gateway 200 may be implemented in multiple forms, architectures, or structures, including, but not limited to, a service or web service, a client-server architecture, a computer implemented method, a network connected data storage medium coupled to a processor that executes instructions that implement the functions and processes of the invention, etc. For example, in a typical implementation, the inventive bridge may be implemented as part of a client-server architecture in which users communicate and exchange data with a server using a suitable communications network. The server includes a processor executing instructions that implement the functions or services of the invention. The client may be a browser, software widget, or form of software agent that is capable of interacting with the server and providing a user UI or other functions as may be needed or desired. As will be discussed, the inventive bridge or gateway 200 enables or facilitates commerce, communications, and other desirable functions or interactions between the real world and a proprietary world or between proprietary worlds, while retaining desired aspects of the proprietary world experience.

Referring to the figure, element 202 represents identity data stored in or otherwise accessible from bridge or gateway 200. Identity data 202 represents identity information that a user of bridge or gateway 200 might provide as part of a registration process, where registering with the bridge or gateway enables the user to utilize the services and functions of the bridge or gateway. Such identity data would typically include a usemame and password, along with other data that may be requested as part of a registration or authentication process. By registering with bridge or gateway, or associated service 200, a user is able to perform various functions related to managing their identities for multiple worlds and/or verifying the identity or reputation of another user (where such verification would typically occur as part of determining if a user wished to engage in an interaction with another user).

Elements 204 represent a connection (or connections) or other form of enabling data transfer between bridge 200 and the communications systems (shown as elements 114 in the figure) within the Proprietary Worlds. Elements 204 couple bridge 200 to communications systems 114, thereby enabling bridge 200 to exchange data between the real world 120 and one or more proprietary worlds 110, or between proprietary worlds. The data exchange can be part of a process of verifying the identity of a prospective participant to an interaction, of associating one identity with another, etc. In general, bridge 200 and its related services and functions provide users with confidence that an identity they interact with via the bridge is being manipulated by the user who is rightfully entitled to utilize it, and if applicable, that the user associated with the identity with which they are interacting is possessed of a reputation or resume of accomplishments that can be accepted as accurate. Coupling the bridge to the communication systems of the proprietary world(s) enables the inventive bridge to connect with most Proprietary Worlds without requiring custom engineering or the development of business relationships for and between the Proprietary Worlds' managers.

The coupling may be achieved in a variety of ways. In some embodiments, participants are used to achieve the coupling. The system delivers tasks to willing participants in the open world aspect of the system who then enter the proprietary world to perform the task with their proprietary world identity. For example, one task conducted using the system is for a user to send a verification message crafted by the system to the requested recipient. Other types of tasks are also possible, such as verifying certain attributes or achievements of the intended identity, participating in a service, or simply conveying a message, and so on.

Element 206 represents an alternative connection between bridge 200 and a Proprietary World coupled to bridge 200. Connection or coupling 206 is depicted as a direct relationship between bridge 200 and the management functions or entity 122 of one or more Proprietary Worlds, instead of between bridge 200 and the communications system 114 of such worlds. The primary benefit of such an implementation of the connection would be simplicity and elimination of the delays associated with user interaction. However, a disadvantage of such an implementation is the need for a technical and possibly business relationship between the bridge and the proprietary world, which is sub optimal for some or all the reasons described previously. Nevertheless, certain worlds may justify the investment cost if adequate business relationships can be established for those particular worlds.

Elements 208, 210, 212 represent a connection, coupling or other form of data transfer or exchange between the identity data (or data store) of a user of a real world commerce system 132, communications system 142, or other system 162 (here depicted as monetary exchange system 160), respectively, and the inventive bridge or gateway 200. In each case or use of the indicated open world system (e.g., commerce system 130), the identity data exposed to the inventive system by a user is the identity the user has deemed most appropriate for the interaction, transaction or system involved. Typically, this is the real world identity relevant to (e.g., associated with) the Proprietary World that the transaction or part of the transaction is designed to occur within.

Note that with the inventive bridge 200 used to manage data such as identities and reputation, and the resulting trust between participants that is engendered, it is now possible to engage in activities that were not possible without use of the bridge, or to have a more desirable experience when engaging in those activities. Enabled activities include:
Creation of a resume or curriculum vitae capturing achievements made in a range of proprietary worlds in a verifiable manner;
Creation of businesses that can use verified identities and reputation to deliver services; and
Creation of games that demand verifiable achievements in multiple worlds.

Current activities which may be enhanced by the inventive bridge include:
Sale of a good in a proprietary world in return for money in the real world. The sales cycle is simplified and more immersive using the bridge; and
Participation in forums and blogs. Verified game identities appropriate to the subject proprietary world can be used rather than real world identities which may have no particular connection, thus raising level of integrity and trust, and retaining the immersive experience.

FIG. 2(c) is a diagram illustrating the functional processes and messages exchanged to verify the ownership of an avatar in a proprietary world in some embodiments of the present invention. The figure also depicts an embodiment of a client-server architecture that may be used to implement certain aspects of the present invention. As shown in the figure, such an architecture typically includes a bridge or gateway server 278 which hosts processes, applications, instructions, or other suitable form that execute on the server. In cooperation with a bridge or gateway process or application executing on a client device (such as those depicted by element 262 in the figure), these processes, applications, instructions, or other suitable form provide the functionality and services of the invention. The client process or application typically communicates with the bridge or gateway server using a communications network and associated client and server network processes (depicted as elements 263 and 277 in the figure). Note that the communications network may be any suitable form of data network, including, but not limited to, the Internet, a wireless network, etc. The client device on which the client processes execute my include, but are not limited to, a personal computer (laptop or desktop), PDA, mobile computing device, wireless phone, etc. The inventive services and functions may be accessed in the form of a web service, hosted application, or other suitable form.

As shown in the figure, a Proprietary World, gaming environment, virtual world or similar construct (in the form of an application, service or similar construct) is hosted on a server, depicted in the figure as element 256. Note that in the description of the invention, reference to a process is understood to include, but not be limited to, a process, application, set of instructions, or other suitable form that execute on a processor and thereby provide the functions and services of the invention. The Proprietary World has an Account Management Process (element 250), where users manage their account with the Proprietary World. Element 251 is a Login process which manages user authentication and authorization functions for participation in the Proprietary World. Element 252 is an Avatar Management process, which provides a user with tools to create, modify, delete and otherwise manage the Avatars for the Proprietary World that are associated with the user. Element 253 represents the Proprietary World application itself, where avatars under the control of the users and computer systems interact. Element 254 represents a communications component of that world, and may be implemented as an email system, a chat system, instant messaging, a voice (or other audio based) system, a visual system, or other suitable communication system or combination or permutation of such systems. Element 255 is a network process to manage communications between the Proprietary World server and the user or user's client devices.

The inventive gateway or bridge is hosted as an application, web service, or other suitable construct on a server, depicted as element 278 in the figure. The inventive gateway or bridge application or service has an associated Account Management Process, element 270, which enables users to manage their account with the inventive system. Element 271 is a Login process which manages user authentication and authorization for the services provided by the bridge or gateway. Element 273 represents the bridge or gateway world, environment, or instance with which the user is interacting. Element 274 is an Avatar Management process which enables a user to record the Avatars they have registered in the Proprietary World. Element 275 is a Key Management process which generates keys (or other forms of verification data), records keys, and compares keys, with these functions typically being performed as part of a function or task to verify the ownership of an avatar. Element 276 is a Task Management process which records tasks, assigns tasks, and records completion of tasks as part of a user or users executing a task or verification process. Element 277 is a network process to manage communications between the Proprietary World server and the user or user's client devices.

In the figure, two example users, User A and User B, are depicted, in the form of their respective client devices, elements 260 and 265. Each of these client devices contains or executes an instance of process 261, which is the client process for the Proprietary World 253, and which communicates with that world through networking process 263. Each device also contains an instance of process 262, which is the client process for the inventive gateway or bridge environment 273.

FIG. 2(c) also shows the messages (or other suitable form of communication) exchanged by the inventive system in an example use case (that of the verification of an avatar's ownership, or a user's claim of ownership of an avatar). In the example, the user account management, login (authentication and authorization), and avatar creation and registration functions are assumed to have been completed satisfactorily. In addition, User B is assumed to have recorded and verified their Proprietary World avatar, Avatar B, with the inventive gateway or bridge.

Message 280 (register avatar) represents User A recording the existence of a new avatar in the proprietary world, Avatar A, with the inventive gateway or bridge. Element 262 (Bridge Client Process) uses element 263 (Network) to transmit this information to Bridge Server 278. Element 277 (Network) receives the information and passes it to element 274 (Avatar Management) which records the information and generates a task using element 276 (Task Management process).

Message 281 represents User B at some later time using the processes represented by element 262 (Bridge client) and element 263 (network) to request a task from the bridge or gateway system. This message is received by element 277 (Network) and passed to element 276 (Task management). Task management element 276 selects a task for User B, in this example, to verify Avatar A and, using element 275 Key Management, generates and records a new key or other suitable form of verification data for this task.

Message 282 represents a response to Message 281. The Task management element 276 uses Network 277 to send a message containing the name of Avatar A (and any other necessary information) and the newly generated key to User B's client element 262.

Message 283 is generated by User B entering the Proprietary World 253 using the Proprietary world client process 261 via network process 255, and sending a message from their Avatar B to Avatar A, using a Proprietary World Communication Process 254. The message contains the key received in Message 282 above. The key may have been copied between Bridge client process 262 and Proprietary World client process 261 by User B using an input device or keyboard to input the key visible in Bridge client process 262 into Proprietary World client process 261, for example. Other suitable mechanisms include “cut and paste,” or another process (not shown) designed to perform this task.

Message 284 is received by User A, using their Proprietary World Client process 261 to receive the key transmitted to Avatar A by Avatar B within the proprietary world. Message 285 represents User A using the Bridge Client process 262 to send the received key to the Bridge server 278. Network process 277 receives the key information or data and delivers it to the Avatar Management process 274 which uses Key Management process 275 to determine if the key is valid by comparing the key to an existing key. If the two sets of key data match, and the received key matches an existing key that belongs to an avatar registered in the Bridge system by User A, then the verification process is considered a success and the avatar is said to be verified.

Element 286 represents a communication link between the avatar management systems of Proprietary World 256 and Bridge Server 278. This is an optional enhancement that may be achievable for certain instances of Proprietary Worlds (generally those subject to special business arrangements). It is shown to demonstrate how such a link may be implemented, and that it can coexist with the inventive user based system. The Account Management elements 250 and 270, and Avatar Management elements 252 and 274 would communicate through the networking processes of elements 255 and 277.

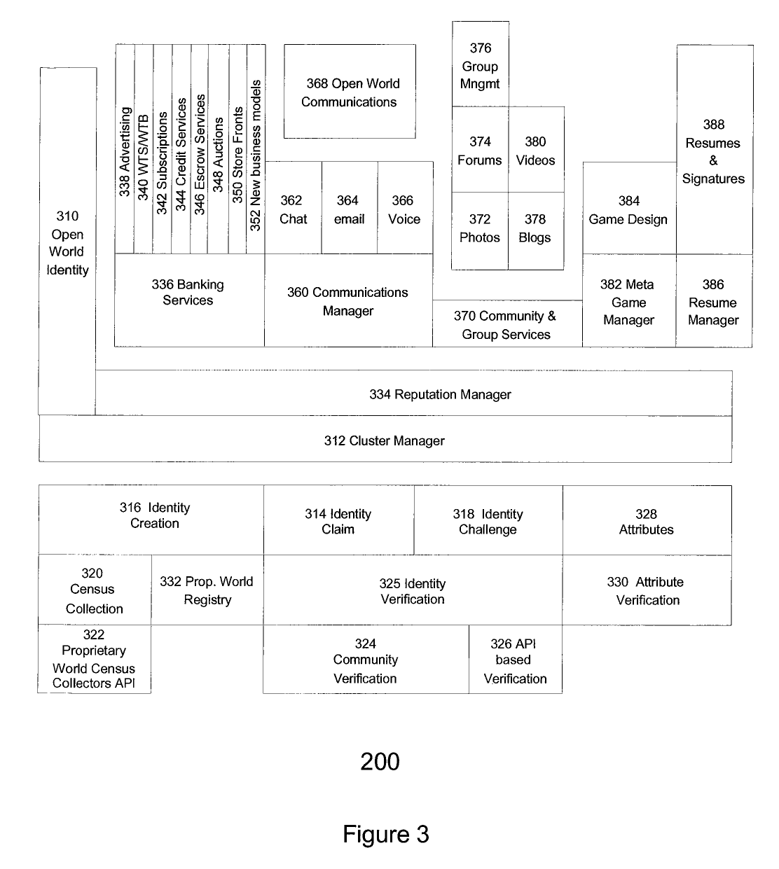

FIG. 3 is a functional block diagram illustrating the primary functional elements of an embodiment of the inventive Identity Bridge 200 of the present invention. The functions, features or processes shown in FIG. 3 are examples of those that can be implemented as part of bridge 200, but are to be understood as exemplary and not required in all embodiments of the invention. One or more of the elements or processes depicted in the figure may be implemented in the form of hardware, firmware, web service, application programming interface (API) or form of software, or a combination of such forms. For example, an element may be implemented as a set of instructions that form a software routine that is executed by a processing element. The processing element may be contained in a computing device such as a server, for example, with the server communicating with a real world user via the user's client device or software and a suitable communications channel or network. The primary function, process, or service provided by each of the depicted elements will now be described.

Element 310 represents a function, process or service that enables a user to register their real or open world identity with bridge 200, or if already registered, to access the bridge functions and services by logging into the system. As has been discussed, and will be discussed further, the inventive bridge or gateway enables this real world identity or identification data to be linked to or associated with one or more sets of proprietary world identity or identification data in a manner that engenders a trusting relationship between prospective participants to an interaction, while maintaining certain desirable aspects of a participant's involvement with those proprietary worlds.

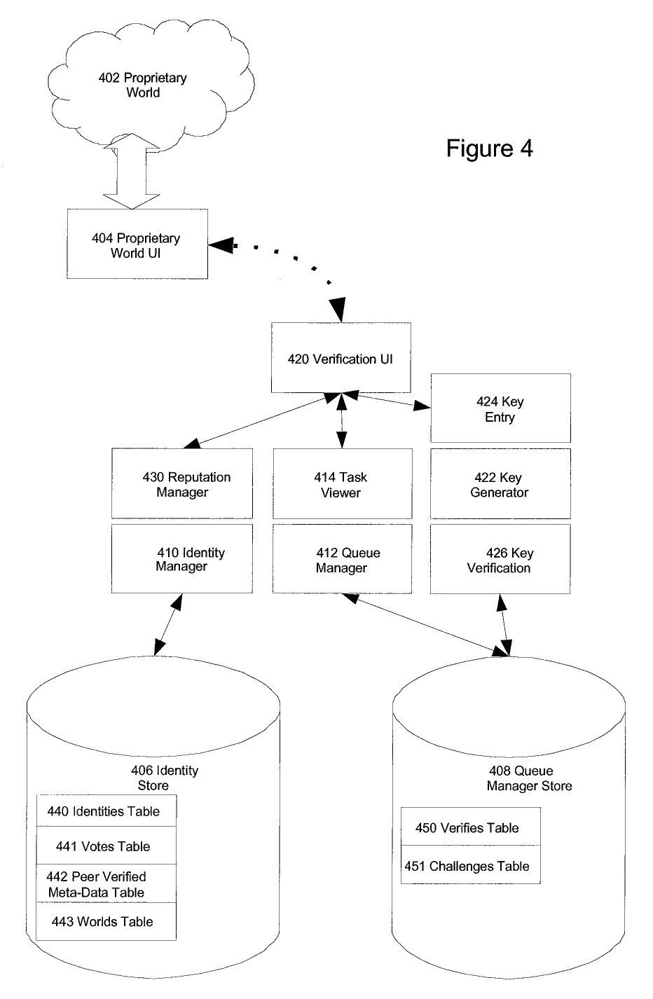

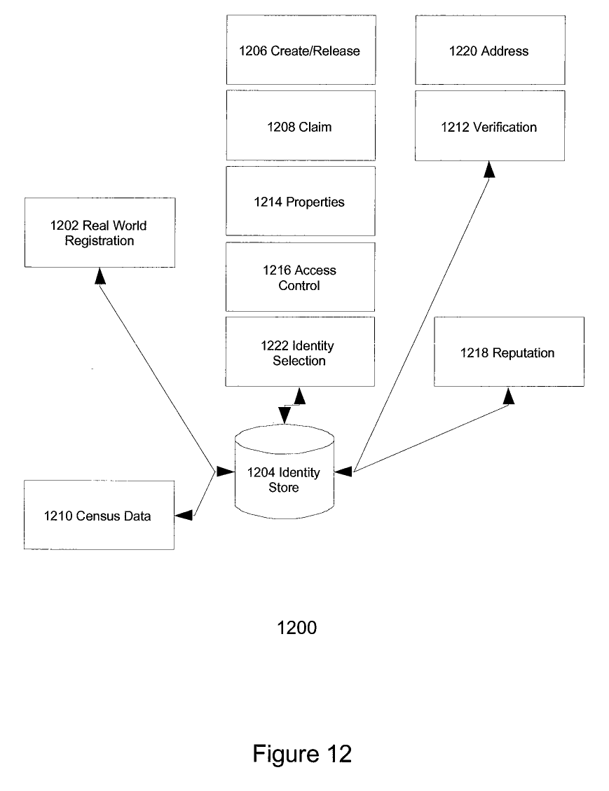

Element 312 (Cluster Manager) represents a function, process or service that connects a user's Real or Open World identity to one or more of their Proprietary World identities. In some embodiments of the invention, Cluster Manager 312 does not reveal the relationships externally. Among other functions, Cluster Manager 312 enables a participant in a proprietary world to select which of one or more proprietary world identities they desire to expose to another participant. Note that FIG. 12 and its associated discussion provide a more detailed description of the components of Cluster Manager of 312 as that element might be utilized in some embodiments of the present invention. The storage of the identity information is described with reference to FIG. 4, with some or all of the functionality of the Cluster Manager being embodied in element 410 of that diagram. Note that Cluster Manager 312 may cause the execution of elements 316 (Identity creation), 314 (Identity Claim), 318 (Identity Challenge) and optionally implemented 328 (Attributes) in response to actions or commands by the user.

In some embodiments of the invention, there are two general ways for identities and identity related data to be entered into, or defined for, the system:
By direct data entry from the user. Element 326 (Identity Creation) represents this method. An identity is typically named by the user, although the system designer may choose to define various rules restricting possible inputs—such as ensuring the identity is not already recorded by the system, checking for syntax, and possibly applying rules reflecting specialized knowledge of the naming schemes of the proprietary world the identity belongs to; and
By claim from a census data set. Elements 314 (Identity Claim), 320 (Census collection), 322 (Proprietary World Census Collection API) represent this method. A census data set is data representing a full or partial list of all the identities known to exist in a particular world or set of worlds. Note that although their existence may be known to the system, the relationship between the proprietary and open world identities is not known. Element 320 (Census collection) represents the data or list and drives the gathering and possible pruning of the list. Since each world is likely to have its own identity list, and its own techniques for harvesting the list, Element 322 (Proprietary world Census Collection API) represents the interface between the system and the individual census collectors. The design, implementation and usage of such collectors is typically a set of decisions for the system designer to make. The concept of claiming an identity enables a user to review the list of identities known to the system and to select one or several of those identities and then assert their ownership of them. This function is represented by Element 314 (Identity Claim). Note that the system may use either or both of these techniques for gathering information related to determining which identities are owned or claimed by which proprietary world participants. In either case, an assertion of ownership has now been made by a user.

Element 318 (Identity Challenge) represents an optional function, process or service that implements a form of fraud prevention by enabling members of the proprietary environment community to challenge a claim of identity ownership that has been made by another user. This function may also assist in determining the valid “owner” of that identity. Note that a possible cause of a loss of identity ownership is that the name of the identity has been recycled to a new user after some event or period of time, and this function can assist in correcting any confusion that may have resulted. This element may be automatically or optionally invoked if the system considers that an identity entered by the user has already been claimed by another user.

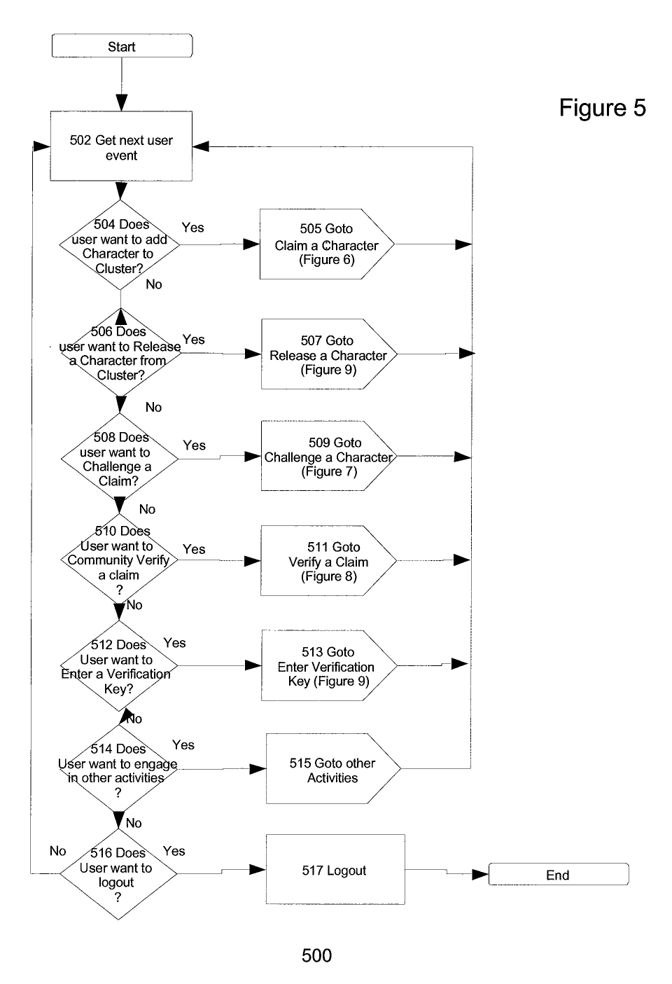

Element 325 (Identity Verification) represents a function, process or service that may be used to verify that a user's assertion of ownership of a proprietary world identity is valid. In some embodiments of the invention, there are two techniques the system may use to check this assertion—the choice being made in some cases according to the proprietary world the identity comes from. Element 325 therefore may invoke one of the following functions or processes:
Element 324 (Community Verification) represents a function, process or service that uses the community of users to perform the verification. This element presents the tasks to users, gathers the results, and manages the interaction. It is described in greater detail in the discussion of FIGS. 5 to 11. A benefit of this Community Verification is that it works with almost all proprietary worlds with minimal or no specialized technical or business activity; or
Element 326 (API Based Verification) represents another possible form of verification in which the system programmatically connects to the proprietary world, or some other related system, for the verification process. A benefit of this approach is the near instantaneous response. However a cost is the difficulty of establishing suitable business and technical relationships with a large and dynamic set of proprietary worlds. Possible embodiments of the verification system or function include direct connection to the Proprietary World account management system.

### Note that other mechanisms that may be used include notarized declarations or documentation.

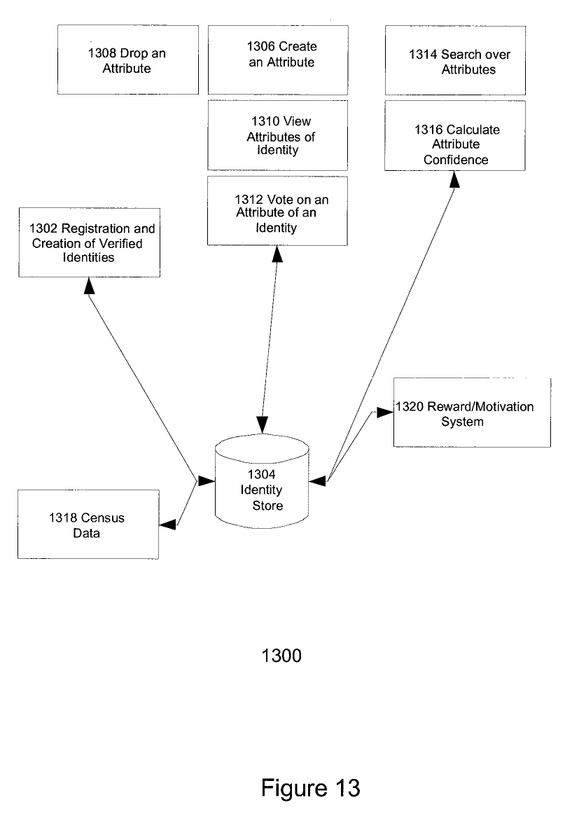

Element 328 (Attributes) represents a function, process or service that enables a variety of attributes to be attached to each identity. Note that to develop and maintain the reputation of the overall system for quality data, it may be desirable that the system enable one or more attributes, or assertions of attributes, on an identity to be verified. Element 330 (Attribute Verification) represents a function, process or service that implements one such mechanism. An example of one implementation of such a feature or function that may be utilized with, or as part of, the present invention is described with reference to FIG. 13, and in additional detail in U.S. Provisional Patent Application No. 60/982,370 entitled “System, Apparatus And Method To Enable Peer Verified Metadata For Use In Interactions Between Real World And Proprietary Environments”, the contents of which is incorporated by reference in its entirety. Note that this verification function or process is a form of community verification or social network based verification and may be implemented as part of, or in response to, a request from element 324, element 330, or other suitable element in the inventive system.

Element 332 (Proprietary World Registry) represents a function, process or service that implements a Proprietary World Registry intended to enhance the user interface experience. In some embodiments, the invention uses a simple list of known proprietary worlds so that the user may select which world a the identity being created comes from, rather than, for example, typing it in.

Element 334 (Reputation Manager) represents a function, process or service that enables participants to view and assess others' reputation as Proprietary World participants without having access to information that would enable them to determine the associated Real or Open World identities. To view the reputation of a participant, the user supplies the name and world of the proprietary world identity of interest. Assuming the identity exists, the system may return reputation information for the identity to the user. This information might include, for example, how many people have voted on the participant, their votes, and some calculations, such as average or median vote value. The exact set of information and calculation that makes up the reputation of an identity in the system is an implementation decision. This element also enables the user to offer their vote on the identity. In some embodiments the inventors have found it advantageous for the Reputation Manager to interact with the Cluster Manager (312) to ensure that the user can only vote once on a particular identity regardless of the number of identities owned by the user.

Element 336 (Banking Services) represents a function, process or service that enables desirable banking services, including but not limited to, payment, reconciliation, currency exchange, and related services for interactions involving participants in proprietary environments. One function of element 336 is to provide an isolation element between the financial affairs of an Open or Real World identity and those of a Proprietary World identity. In this way it enables participants to engage in commercial transactions using their Proprietary World identities as a participant in the interaction.

As examples of possible interactions enabled or facilitated by element 336, elements 338 to 352 (Advertising, Bazaar (real time trade), Subscriptions, Credit Services, Escrow Services, Auctions, Store Fronts, New Business Models) represent functions, processes or services that correspond to implementations of business models partially or fully enabled by commerce services element 336. Note that as mentioned, such banking services enable or facilitate using Proprietary World identities as part of a transaction that involves the generation, payment, transfer or exchange of actual real world or proprietary environment currency.

An advantageous feature of a system using the inventive bridge is that two views may be generated for each part of each transaction. The first view shows the participant information (such as a transaction history) using their real world identity. The second view shows the same information using proprietary world identities. The system would optimally filter access to each view such that only the owner of an identity would be able to make the connection between the real world and proprietary world identity. The system would optimally further filter to ensure that the connection between multiple proprietary world identities was not apparent, unless the owner chooses to reveal such connectedness. A variety of book keeping functions can also be implemented by the system using this information to deliver additional benefits to users in terms of tracking identities and the related activities of those users owning those identities.

New business models that are enabled include, but are not limited to, the creation of meta-games that might charge an entry fee, and micro-businesses in which the owner wishes to be totally known by their proprietary world identities.

Element 360 (Communications Manager) represents a function, process or service that enables a variety of communications systems and methods to be used by a participant in a transaction or interaction. Note that in such transactions or interactions, at least one participant will typically be represented by a Proprietary World identity. In order to facilitate such transactions or interactions while retaining certain desired aspects of participation in a proprietary world, messages or other forms of communication can be exchanged between participants (in either the Real World or a Proprietary World) without exposing a Real or Open World identity. Further, messages or other forms of communication directed to an identity in a user's cluster or group of identities can be managed, so the user can participate using whichever one or combination of their Proprietary World identities they select.

Elements 362 to 366 represent examples of possible communication systems or methods that may be enabled or facilitated by Communications Manager 360. As shown in the figure, such possible communications systems or methods include Chat (362), email (364) and Voice (366) communications. Note that Communications Manager 360 will typically interface with, or be coupled to, any required Real or Open World Communications systems (represented by element 368) to enable such communications.

Element 370 represents a function, process or service that enables participants to access services or features designed to support community or social networking services. Examples of such services are represented by elements 372 to 380 (Photos, Forums, Group Management Functions, Blogs, and Video content), where such services or features may be enabled and/or facilitated by the inventive bridge or gateway. A benefit of using the inventive system to manage identities is that contributions to the forums, etc. can now be made using verified proprietary world identities. It becomes possible for the viewer of the content to see that the participant delivering the content really is the participant referred to in the content or affected by the content—yet there is no need for the participant to reveal any real world information. The derivative benefits include that effective impersonation is eliminated, greater immersion is achieved (a proprietary world identity may be reliably used), and quality of content is improved (assuming that with clearer ownership comes greater responsibility for accurate and truthful discourse).

Elements 382 (Meta Game Manager) and 384 (Game Design) represent functions, processes or services that may be used to support the creation and participation in proprietary or gaming environments and that take advantage of the features of the inventive Identity Bridge. For example, element 384 represents the ability for users to create games that take place wholly or partially in multiple Proprietary Worlds.

Element 382 (Meta Game Manager) enables the system to present new kinds of games to participants that take advantage of the beneficial features of the system. For example, a proprietary world identity can be created for the games, and all aspects of participation (such as collecting entry fees, or recording achievements) can be delivered to the user while concealing their real world identity. Note that Cluster Manager of 312 may be used for those games where the participant must interact with multiple worlds. Element 384 (Game Designer) provides access to the information that is more appropriate for the game designer—for example, setting a name for the game, listing the clues, tracking progress, and publishing the existence of the game.

Element 386 (Resume Manager) represents a function, process or service that enables a participant to access data to build a resume describing their Proprietary World activities and achievements. A signature is an image or block of text, or combination of both which a user might attach to any community content (such as elements 372 to 380) they generate. Generally, existing signatures are considered valuable, yet are constructed by the user with information supplied by the user and are therefore unverified. Element 388 (Resumes and Signatures) represents a function, process or service that implements applications that utilize the data made available by element 386, such as ways to view the Resume, and create signatures generated from the trusted information available to the system. Such resumes and signatures are advantageous because the information is verified, as opposed to being unverified and potentially fraudulent.

In some embodiments, the inventive identity bridge, architecture, or gateway enables participants in one or more proprietary environments or activities to interact with each other using proprietary world identities. In such situations the proprietary world identities, personas, avatars or similar constructs are used to represent the real world identity of a user and the inventive system and services enable interactions to occur between participants without disclosing the connection between a proprietary world identity and a real world identity. The invention further enables a user to manage their identities and related data by bringing many or all of their proprietary world identities together in one place, and enabling connections between those identities to be revealed, thus enabling, for example, the creation of a detailed and long lived resume of multiple world achievements containing verified information.

Note that in some situations, the accuracy of representations made by a proprietary identity and the truthfulness of the relationship between an open or real world identity and a proprietary world identity may depend on the honesty of the participants. This degree of reliability may be sufficient for some activities, such as blogs, forums, and exchanges of information or opinion, but may not be sufficient to adequately support commercial transactions where accountability, non-repudiation or fraud detection are desired or required characteristics of an interaction.

Therefore, as the inventors have recognized, it is desirable and in some circumstances may be required to provide a means to upgrade the degree of trust that can be placed on the correspondence between Real World and Proprietary World relationships. In general, the degree of trust achieved should be sufficient to support commercial transactions and other desired interactions where a high level of authentication and identity confirmation is desired or required (e.g., to ensure non-repudiation, fraud detection, etc.).

In this regard, in addition to the previously mentioned problems or obstacles to bridging the two types of worlds that were discussed previously, the following problems or obstacles to developing a system or service that provides an enhanced degree of trust for interactions and business relationships that occur inter-world (that is between the real world and a proprietary world, or between two proprietary worlds) or intra-world (that is within a proprietary world) may exist and have been recognized by the inventors:
Variety of Proprietary Worlds—there are many different Proprietary Worlds run by many different organizations. There is unlikely to be a single programmatic method that can be used to interact effectively with all of them;
Scale—the number of Proprietary World identities that may need to be verified is measured in the millions or tens of millions. Any solution must be able to handle these numbers and scale accordingly;
Content Licensing—each Proprietary World has its own licensing policy around handling of their content—referring in this case to their participants' identities and key properties of those identities. An effective solution should accommodate and successfully address these licensing and related intellectual property issues;
Movement—Proprietary World identities can be moved between players. The system should be able to track and support such exchanges or transactions;
Anonymity—the relationship between Open or Real World and Proprietary World identities is valuable to the participants. An effective solution should preserve a participant's desired level of privacy;
Recycling—Proprietary World identities may be passed on to new participants when the original participant has ceased using them. An effective solution should be capable of resolving any confusion that may result from such recycling;
Attributes—a Proprietary World identity may develop many attributes over time that are perceived as valuable by the owner. These include (for example) attributes essential to the identity, attributes that are earned by overcoming challenges or rewards, and attributes that the owner chooses to add themselves. An effective solution should provide a means of recording and verifying that these attributes really do belong to or describe the identity, as they make up a significant component of the identity's reputation and perceived value; and
Experience—Proprietary World participants frequently enjoy the immersive experience that the environment provides. An effective solution should have a minor or negligible impact on the immersive qualities of a participant's experience with the proprietary world or environment.

As recognized by the inventors, a proposed solution to these and other problems or obstacles is a community based system whereby the participants themselves are involved in the identity verification process using an available Proprietary World communications system. As further recognized by the inventors, one characteristic of a typical proprietary world communications system is that only the particular participant under whose Proprietary World account an identity was created can receive a communication sent to that identity. However, any participant whose identity meets certain Proprietary World defined requirements, such as being of a particular skill level, or having access to a mailbox, or having financial resources to pay for a message, etc., may send a communication to the identity in question. This aspect of proprietary world communications is utilized by the inventors in the construction of an inventive system which can verify, for any proprietary world, that a particular user owns a particular proprietary world identity (and that no other user owns that identity).

Thus, in some embodiments, the inventive system, architecture, platform, etc. may include the following elements or components:
an element to enable participants/users to assert ownership of a particular identity in a Proprietary World. This enables the user to convey to the system which proprietary world identities they own, and in which proprietary worlds they exist;
an element to enable community members to participate in the verification of that ownership assertion. This enables the system to ask a user (User A) to send a message containing a code to a particular proprietary world identity (Identity X);
an element to enable participants/user to confirm receipt of a code. This enables a user (User B) to demonstrate that they own an identity (Identity X) by conveying to the system a code that was delivered to (and only to) Identity X; and
an optional element to enable community members to challenge an assertion of ownership of an identity that they believe may be false. This enables a user (User C) to assert they own an identity (Identity X) that the system may previously have recorded as belonging to a different user (User B).

The following describes an exemplary implementation of certain features of the inventive system or service. As will be understood by one of skill in the art, there are variations possible that fall within the scope of the invention and do not alter the essential functions of the system or the inventive concepts.

FIG. 4 is a functional block diagram illustrating the primary functional components of one embodiment of the inventive community based identity and reputation verification system. Note that in some embodiments, some or all of the functionality of the elements of FIG. 4 corresponds to that of Elements 324 and 325 of FIG. 3.

As shown in the figure, a participant or user of a proprietary world or environment 402 may interact with the inventive system or services using a Proprietary World User Interface 404. This element represents a function, process or service that provides the user interface(s) used by a community member and a person asserting ownership of an identity to access the Proprietary World. It is also the interface the member uses to send a message using one of the Proprietary World's communications systems to the participant to be verified, and also part of how the person asserting ownership of the identity receives the message. Proprietary world UI 404 may be used by a participant in a proprietary world to access verification UI 420 as part of participating in an identity verification process or task.

Element 406 (Identity Store) represents a function, process or service that functions as a database for storing information about each identity. Identity Store 406 stores information or data used to identify the identity in the Proprietary World, and may also store address or contact information used by a Proprietary World communications system. It is also generally useful to record/store information about the state of the verification process for an identity. Data tables in Identity Store 406 may include Element 440 (Identities Table) which has a record for each Identity in the system, and includes such information as the name, the proprietary world, date of creation, whether it has been verified or challenged, etc. Element 441 (Votes Table) represents a table of Votes, every vote is recorded, along with the identity making the vote, the identity being voted on, the value of the vote, and (optionally) a comment on the vote. Element 443 (Worlds Table) represents the Proprietary World table and has a record for each world or instance managed by the system—this is optional and generally only included to improve the user experience (enabling the user to pick a world from a list, rather than typing it in, for example). Peer-verified meta-data table 442 represents data related to the peer verification process in which other participants in a proprietary world may provide inputs (such as votes) regarding the accuracy of a proprietary world identity's characteristics or qualities, for example.

Element 408 (Queue Manager Store) represents a function, process or service that acts as a data store for identity verification tasks scheduled to be performed by the inventive system. It may be desirable (but is not required) to store the security keys being used for verification in this element. Element 450 (Verifies Table) represents a table with a record of each verification task, including the identity to be verified, the identity performing the verification, whether the task has been assigned or completed, and when the task was created, assigned, or completed, etc. Element 451 (Challenges Table) represents a table with a record for each challenge task, recording the identity being challenged, the identity issuing the challenge, the identity assigned the challenge task, as well as status and date information.

Element 410 (Identity Manager) represents a function, process or service that acts to provide a user with identity management functions for their one or more proprietary world identities. Among other functions, this element enables a user to assert that they own, or are responsible for, an identity in the Proprietary World. This information is stored in Element 440. When a new assertion of identity ownership or control is made, Identity Manager 410 also posts a task to Queue Manager (Element 412) which stores it in the Queue Manager Store (408) in the Verifies Table (440). Typically, this “task” will be for another participant in the proprietary world to assist in verifying the ownership or control claim by executing the task.

Another function that may be implemented or enabled by Element 410 is that of enabling a participant or user of a proprietary world or environment to challenge an assertion by another person of that other person's control of or association with an identity. For example, if User A attempts to assert ownership of or association with an identity in a Proprietary World and finds that someone else (e.g., User B) has already made that assertion, then User A may challenge the ownership assertion of User B. This function is useful in reducing fraudulent claims to an identity, facilitating honest changes of ownership, and building confidence in the user community.

Element 414 (Task Viewer) represents a function, process or service that enables a user to view tasks in the task queue, select a task or tasks for execution, and monitor the progress of the execution of that task. Task Viewer 414 typically functions with Element 420 (Verification UI), which serves as the user interface for the verification processes, to enable a user to select tasks and monitor their execution. In some embodiments, Task Viewer 414 may filter the available tasks to ensure a user or community member is only presented with tasks that meet pre-defined criteria, where such criteria may include, but are not limited to, whether:
the member has an identity of their own in the Proprietary World that will be able to contact the task's target identity;
the member is not also the owner of the identity; and
the member has previously worked with this identity (in the case of a challenge, for example).

In one implementation, Task Viewer 414 may instruct Queue Manager 412 to record that the task has been delivered to a community member or proprietary world participant, and not to show the same task to other members or participants. In addition, in some embodiments, the system or service may have a member confirm that they have acted on a task before recording data in the task record. Further, Task Viewer 414 may provide an interactive view of the tasks, or a static list or report that is generated in response to a user's request or command, in particular for the benefit of an Administrative user monitoring the system.

Element 422 (Key Generator) represents a function, process or service that Task Viewer 414 and User Interface 420 may utilize to generate and record a key or other security or verification data that the community member sends to the target identity (that is to an avatar, character, persona, etc. in a proprietary world) as part of the verification process. The target identity would then be expected to enter this key into the system on receipt of the message carrying the key (where the key or other data would typically be communicated to the target identity using a proprietary world communications system). Typically the key will be randomly generated string or number, but may (depending on the proprietary world) be a sequence of sounds or visual motions.

As discussed, element 404 is a user interface used by a community member to access the functions, processes or services of the invention while operating in a Proprietary World. As noted, in some embodiments, it is used by a community member to send a message using one of the Proprietary World's communications systems to the proprietary identity in question, and also the element that enables the person asserting ownership of that identity to receive and access the communication.

On receipt of the verification key, the person asserting ownership (that is the recipient of the key or other authentication data) may use the interface represented by element 420 and the function, process or service represented by element 424 (Key Entry) to enter the key for their Identity into the system. The key entry process will typically be followed by a function, process or service that verifies the authenticity of the key (represented by element 426 entitled “Key Verification”) by comparing the entered key against that recorded by Key Generator 422 for the Identity. If the comparison indicates a match between the two sets of key data, then the system will assert that the Identity has been verified. If the comparison indicates that the two sets of key data do not match, then the system will not make that assertion. In response to a comparison that does not indicate a match, the system may optionally:
Prompt the person for a new or corrected key;
Ignore the key entry; or
Reset the verification task to be performed again.

Element 430 (Reputation Manager) represents a function, process or service that provides an opportunity for a person who has their identity verified to rate their experience and that of the member who sent the message. This element is optional, and the system designer may choose to have such data updated by the system rather than by a user. It is expected that the opportunity to build reputation in some manner such as this is a strong incentive for community members to participate in the community verification task.

FIGS. 5-11 and the associated descriptions provide additional detail on how certain of the described functional elements or blocks operate and co-operate to provide the functions, processes or services of the inventive system. It is noted that one of skill in the art would recognize that other implementations are possible and are understood to fall within the scope of the present invention.

FIG. 5 is a flowchart illustrating an exemplary process 500 for the operation of a user driven interface for managing a user's identity in some embodiments of the present invention. Typically, the user interface receives commands and data from a user, through a client on the user's device, via a website, or another element or process. Note that a logon or authentication and authorization step is typically utilized. In some embodiments, FIG. 5 corresponds generally to the functionality of Element 420 of FIG. 4 and with reference to elements 314, 316 and 318 of FIG. 3.

As shown in the Figure, in some embodiments, process 500 begins by accessing a user event or task from a queue (stage 502). Process 500 then uses data associated with that event or task to determine what the user desires to do, and based on that, routes the processing to the appropriate software sub-routine or process. Examples of possible events or tasks may include, but are not required to include and are not limited to, adding a character or avatar to an identity cluster (stage 504, which if selected passes control to stage 505), releasing a character or avatar from an identity cluster (stage 506, which if selected passes control to stage 507), challenging another user's claim of control or association with a character or avatar (stage 508, which if selected passes control to stage 509), initiating a community based verification of a user's claim of control or association with a character or avatar (stage 510, which if selected passes control to stage 511), entering a verification key as part of confirming a claim of control or association with a character or avatar (stage 512, which if selected passes control to stage 513), engaging in other activities (stage 514, which if selected passes control to stage 515), or logging out to terminate the process (stage 516, which if selected passes control to stage 517).

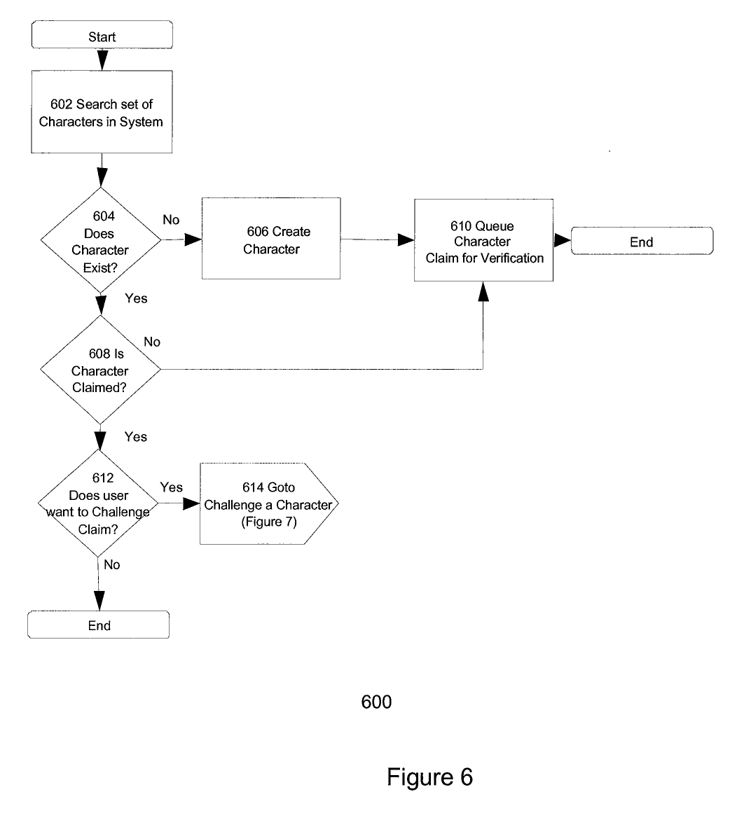

FIG. 6 is a flowchart illustrating an exemplary process 600 for enabling a user to claim or create a character or avatar for use in a proprietary environment in some embodiments of the present invention. In some embodiments, certain aspects of the functionality of FIG. 6 may be provided in Element 420 of FIG. 4, again with reference to Elements 314 and 316 of FIG. 3. Note that in accordance with FIG. 5, this process or routine would be accessed by stage 505 and after execution, would return control to process 500. In the context of the present invention, “character” is used to refer to an identity used by or associated with a participant in a proprietary world. As shown in the figure, process 600 may start with stage 602, which is an optional process to permit a user to initiate a search of the set of existing characters in the system or proprietary world, both those belonging to other users, and those recorded in some optionally implemented provided set of characters. This stage can be used to enable a user to identify a character they desire to claim as their own.

If stage 602 is not present or if the user does not identify a character they wish to claim, assert ownership of, utilize, or otherwise be associated with, then stage 604 may be used to enable a user to create a character or avatar (stage 606). Creation of a character or avatar will generally involve selection of certain traits or characteristics that identify the character, where it is located, and how to contact it. After the user completes the character creation process, the data may be saved to a database and the task of verifying the character may be queued for execution (stage 610). A typical implementation of this stage would be to add a record to a database table which represents the queue. An optional variation would be to enable the user to assert that they do not wish the relationship to be verified. The system would record that assertion and the community and system may place a lesser degree of trust in that proprietary world identity.

If the user does identify a character or avatar they wish to claim, assert ownership of, utilize, or otherwise be associated with, then control is passed to stage 608 where it is determined if that character or avatar is already claimed by another user. If the user claims a currently unclaimed character, then control is passed to stage 610 at which stage the claimed character is subject to the verification process previously discussed. Note that another possible implementation of stage 608 is one in which the system obtains the identity information from another system, such as a census collection mechanism, character library, or form of business partnership that provides candidate characters or avatars. In such an implementation, the data may be exposed through tables in the database or by a web service. In this implementation, a user may assert ownership of a selected character, after which this information is recorded in the database, and a verification task is queued (as in stage 610).

If the character or avatar is claimed by another, then the process enables a user to challenge that claim of control, etc. (stage 612). If a challenge is desired, then control is passed to stage 614 (which in accordance with FIG. 5, would be accessed by stage 509 and after execution, would return control to process 500). If no challenge is desired, then the process terminates.

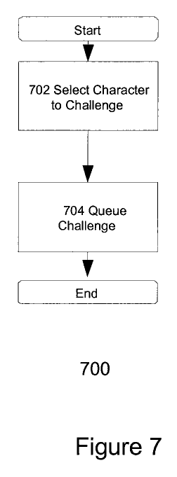

FIG. 7 is a flowchart illustrating an exemplary process 700 for enabling a user to challenge an assertion by another of ownership or control of a character or avatar for use in a proprietary environment in some embodiments of the present invention. In some embodiments, certain aspects of the functionality of FIG. 7 may be provided in Element 420 of FIG. 4 and/or Element 318 of FIG. 3. Note that this process is optional, but may be useful to reduce fraud and enhance trust between participants in the community or proprietary environment. Referring to the figure, at stage 702, a character or avatar is selected or otherwise presented as the object of a challenge (note that this may be accomplished by entering data directly, searching over a set of characters stored in the system, or another suitable method). At stage 704, the challenge task is queued for execution, typically, although not necessarily in the same queue as other identity claims. Generally, the function of the challenge is to enable a first user who believes that a character they own or control has been claimed by a second user to cause that claim to be revoked. In one implementation, the challenge may be executed by a community based mechanism, in which case it may be similar in function or process to that of the community based verification system or process that has been described. Alternative implementations may include utilizing an agent to check the basis of the claim, or a direct query to the Proprietary World systems to determine ownership and resolve a dispute. Typically, processing a challenge to a claim of ownership of an identity can be handled by the system in the same or a similar way that a standard claim verification is performed.

Note that an optional enhancement to the process described with reference to FIG. 7 is to place one or more tests or filters between stage 702 and stage 704. These tests or filters may be intended to increase the likelihood that only genuine challenges are issued, to instill a perception of the seriousness of issuing a challenge, or to discourage use of the challenge process where desired. Possible tests may include, but are not limited to:
Ensuring that only a trusted user (meaning a user with a good reputation) can issue challenges;
Ensuring that a user may only issue a limited number of challenges;
Limiting the frequency with which a user may make challenges;
Ensuring a user has their own Identity in the Proprietary World in question; and
Checking for past invalid challenges.

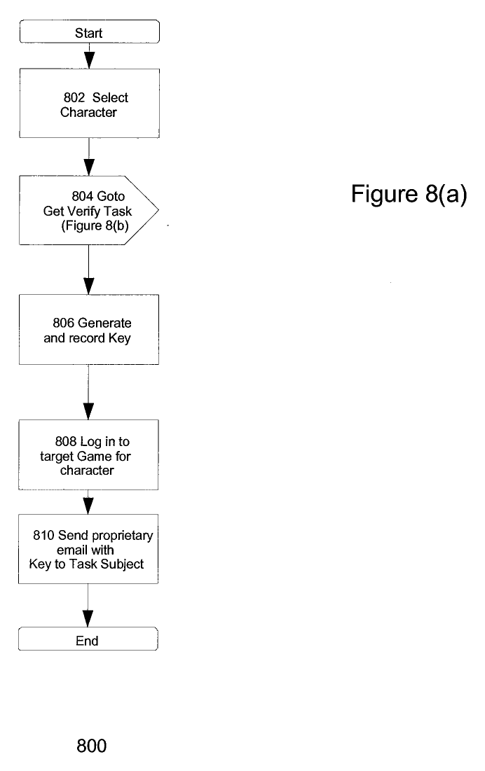

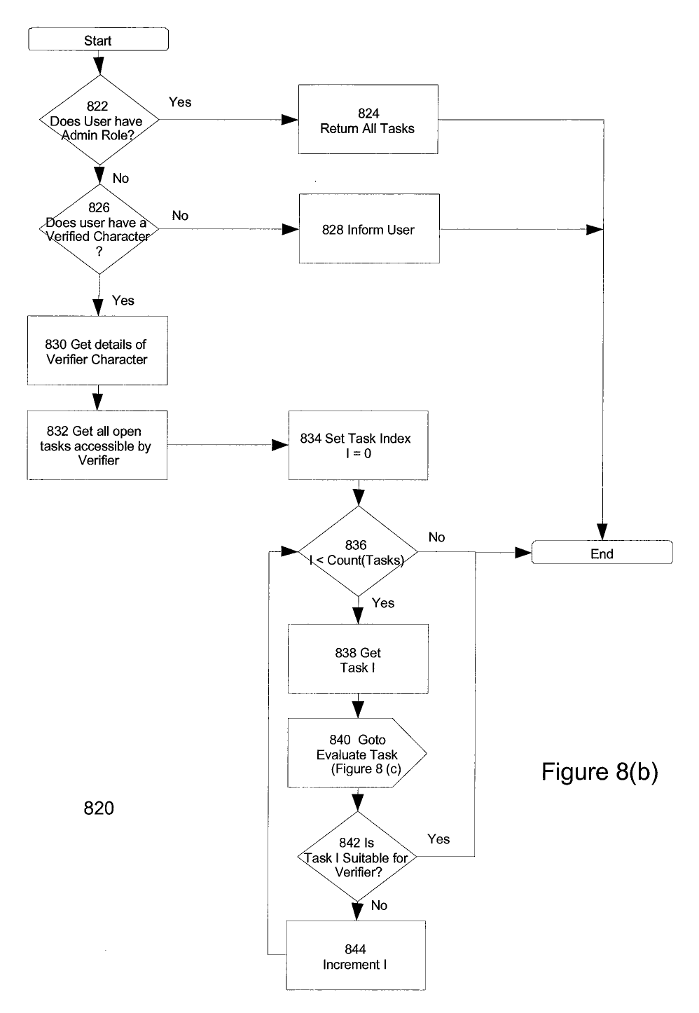

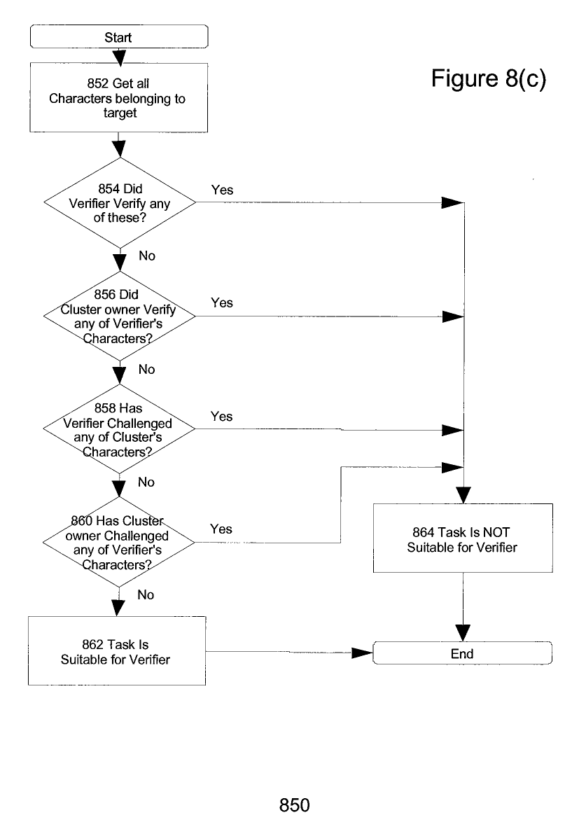

FIG. 8(a) is a flowchart illustrating an exemplary process 800 for enabling a user to verify a claim by another of the control of a character or avatar for use in a proprietary environment in some embodiments of the present invention. Note that in accordance with FIG. 5, this process or routine would be accessed by stage 511 and after execution, would return control to process 500. As shown in the figure, at stage 802 the community member performing the verification process chooses the identity they will be using in the Proprietary World for the task. In some implementations, this stage may be optional; however, it has value as it assists in selecting an appropriate verification task for the user, as occurs at stage 804 (and as will be described in greater detail with reference to FIG. 8(b). An output of stage 804 is a task that is suitable for the user to execute.

Note that in some embodiments, the system will then create a record of the task that has been selected for the user. An optional variation would be for the system to give the user the choice of accepting the task, or getting another. A further option would be to show a set of tasks and allow the user to choose the ones they would prefer to perform.

Stage 806 (which in some embodiments, may correspond to certain aspects of Element 422 of FIG. 4) represents a function, process or service in which the system generates a security key that is sent to the target identity. The key is also stored by the system for matching when the participant whose character receives the key enters it into the system. Any of a variety of known key generation strategies maybe used. For example, the key may be a randomly generated string of some length determined by the system or designer. Another implementation is to generate a public/private key pair, with the system recording the private key and the user being given the public key. The generated key may also be provided to the user. A further option is to present the user with an example of a message that the user may use when sending the key to the intended recipient.

In stage 808 the user logs into the Proprietary World with the appropriate client or browser, if they have not already done so. In stage 810 the user sends a communication to the proprietary identity being verified using one of the appropriate Proprietary World communications systems. The communication may include the key that was generated in stage 806.

Note that an alternative implementation for some or all of the steps of FIG. 8(a) is to use an automated process or agent to obtain a task and, automatically though an API for the Proprietary World (or equivalent method) perform the task of sending the Proprietary World email or other communication described. Similarly, another alternative implementation for some or all of the stages of FIG. 8 would be to have a company agent perform the work described for the community member.

FIG. 8(b) is a flowchart illustrating an exemplary process 820 for obtaining an appropriate verification or other task for a community member to perform in some embodiments of the present invention. In some embodiments, FIG. 8(b) represents an implementation of certain of the functionality of Elements 412 and 414 of FIG. 4. Note that an alternative implementation would be to randomly select a task and perform fewer or no tests for suitability. Such an approach may be more suitable when the community is large and/or infrastructure resources are limited.

At stage 822, the process checks to determine if the user has an administrative role or is otherwise entitled to or has privileges to view all tasks queued for execution (stage 824). This is an optional stage that may be useful in management of the system. At stage 826, which is another optional stage, the system checks whether the particular user has any previously verified characters associated with that user. If not, the system cannot be sure that the user will be able to perform a verification process and may inform the user (stage 828) and terminate the process. Note that an alternative is for certain functions in new worlds or instances of worlds to be handled by an administrator until a sufficient community has been built up for that world.

If a user has a verified character, then at stage 830 the process accesses or otherwise receives a data about the user's character, such as the Proprietary World it is registered for. This information could be obtained from a database, or information the user entered themselves. At stage 832, the system uses the information about the character and its capabilities, etc., to obtain a list of tasks suitable for that character to verify. The set of tasks may be obtained by querying the verification queue, which would typically be implemented as a table in a database. Note that the set may optionally include tasks that have expired without being completed.

Once the set of suitable tasks (or filtered set to identify tasks fulfilling another criteria) are obtained, the process implements an iterative loop through the suitable tasks. This occurs in the processes shown in stages 834-844 of the figure. These stages generally implement a counter to step through the task list, retrieve the task, and evaluate the task for suitability (as will be described in greater detail with reference to FIG. 8(c)). Stage 842 acts to terminate the loop if a suitable task is found. An alternative implementation would be for a longer list of suitable tasks to be generated before the loop is terminated.

FIG. 8(c) (which in some embodiments corresponds to certain of the functionality of Elements 410, 412, and 414 of FIG. 4) is a flowchart illustrating an exemplary process 850 for evaluating a proposed task to determine if it is suitable for execution by a community member in some embodiments of the present invention. As will be discussed, process 850 applies a series of tests to a candidate task to determine if it is suitable for a particular community member to execute. The set of tests depicted in the figure are exemplary and not required, and it is to be understood that other tests or filters may also be applied. The tests or filters shown in the figure are intended to determine whether the community member and the owner of the target identity have had any previous relationship through the identity verification system. An example of another possible test would be ensuring the task has been queued for some minimal time period. Note that the data the system uses to perform the tests may have been collected by the system over time, as various tasks have been executed, completed, or discarded.

At stage 852, the system accesses or otherwise obtains a set of desired information about all characters the system has a record of being claimed, owned or otherwise associated with the community member, and all characters that have been claimed, owned or otherwise associated with the user who made the ownership assertion that is the subject of the task. At stages 854-860 the process applies a set of the tests to determine the existence of any previous identity verification interactions between these two users. If all tests fail, then this verification task would be considered suitable for the user to perform (stage 862). If any of the tests results in a positive decision (as indicated by “Yes” in the process flow), then the verification task would be considered unsuitable for the user to perform (stage 864).

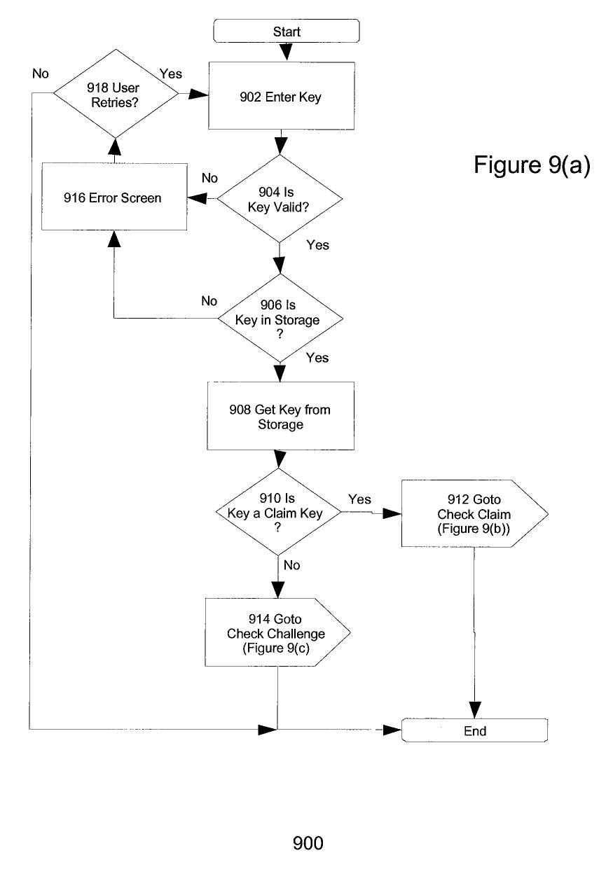

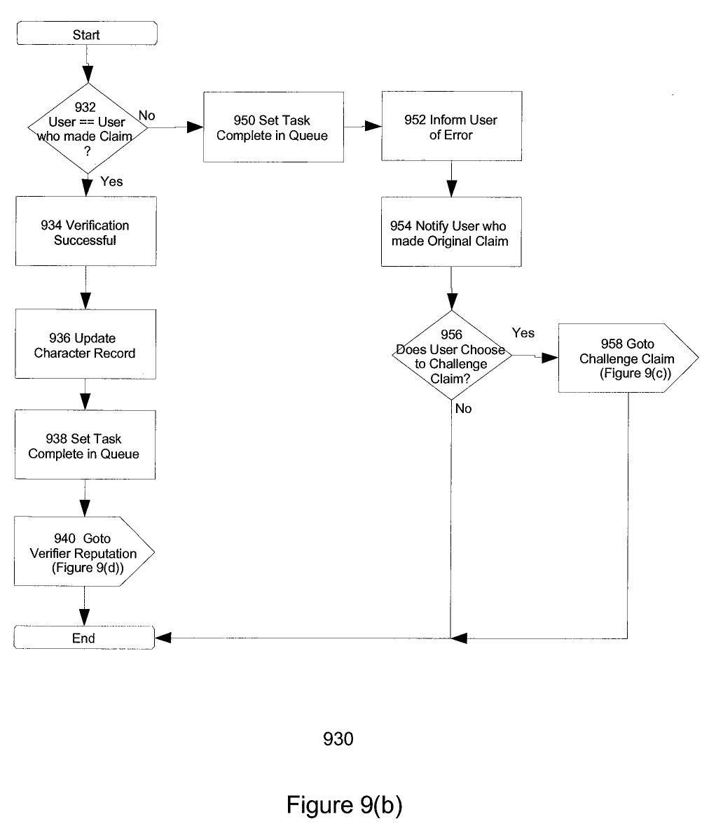

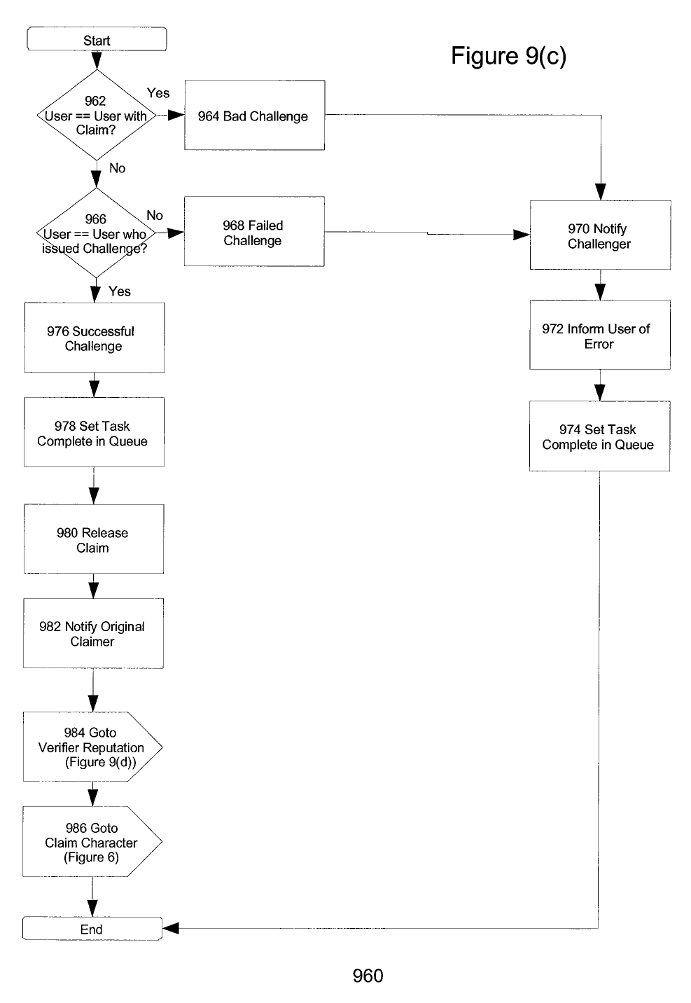

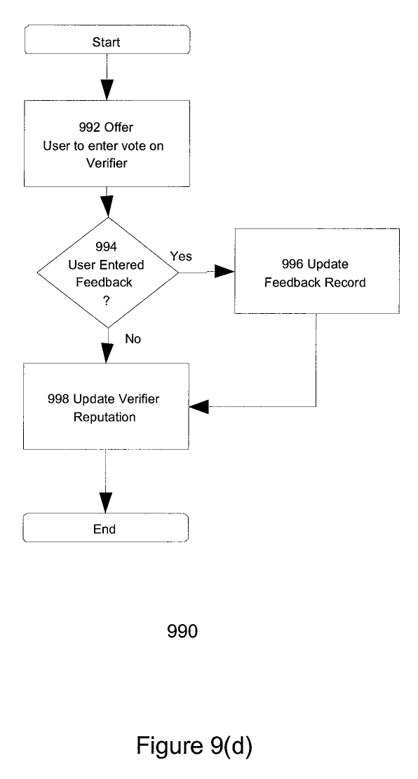

FIG. 9(a) is a flowchart illustrating an exemplary process 900 for verifying a key or other security or authentication data for asserting a claim of ownership for a character in some embodiments of the present invention. As shown in the figure, at stage 902 a user enters key data. At stage 904, the process checks to determine if the key data is valid. Note that in the context of the invention, the validity of a key or key data will depend on the particular key solution or format being used.

At stage 906, the process determines if the key is in storage, and causes an error message or notification to be issued by the user interface if is not (stage 916). At stage 908, the process accesses or otherwise retrieves the corresponding key from where it was stored in stage 806 of FIG. 8(a) as part of issuing the verification task. At stage 908 the process determines if the key is being used to verify a claim, or is part of an optional system to manage a challenge to a claim. If it is determined in stage 910 that the key is a claim key, then control is passed to stage 912 and the process or service to be described with reference to FIG. 9(b) is executed. If it is determined in stage 910 that the key is not a claim key, then control is passed to stage 914 and the process or service to be described with reference to FIG. 9(c) is executed.

FIG. 9(b) (which in some embodiments corresponds to certain of the functionality of Element 426 of FIG. 4) is a flowchart illustrating an exemplary process 930 for testing whether the claim key is valid by determining if the user entering the key is also the user who made the original assertion of ownership of the character. In some embodiments, this process may be performed by checking the data recorded by the system when the original claim of character or avatar ownership was made. If process 930 determines that the claim key is not valid, then an error message may be generated as an indication of a possibly fraudulent claim. As shown in the figure, at stage 932 the system determines if the user entering the claim key data is the same as the user who previously asserted ownership or control over the character. If the two users are found to be the same, then the user verification is deemed successful (stage 934) and the character record is updated to reflect the status of the verification task (stage 936). The task status is set as completed in the task queue (stage 938). Control then passes to the process to be described with reference to FIG. 9(d) which is a process to provide the user the option of rating the community member who issued the verification message (stage 940).

If at stage 932 the system determines that the user entering the claim key data is not the same as the user who previously asserted ownership or control over the character, then control is passed to stage 950, in which the process sets the task to be complete in the task queue. At that point, the process may notify the user of the failure of the claim key verification process (stage 952) and then notify the previous claimant to ownership of the character of the failed task (stage 954). The system may also optionally provide the user who entered the claim key with an opportunity to utilize the system's ownership challenge function(s), as indicated in the figure at stage 956. If the user wishes to utilize the ownership challenge function(s), then control is passed to stage 958, which leads to the execution of the process that will be described with reference to FIG. 9(c).

FIG. 9(c) is a flowchart illustrating an exemplary process 960 for executing a challenge process to the claimed ownership of a character or avatar. As shown in the figure, at stage 962 the process determines if the user entering the key is the user who asserted ownership of the character by checking the database records for the character and user. If this is true, then such a situation would indicate that the challenge was defeated and that the user's assertion has essentially been re-validated. In response, at stage 964, the system records this as a “bad” challenge and may, optionally, record this against the challenging user's reputation or other data.

At stage 966, the process determines if the user who entered the key is also the user who issued the challenge to the ownership of the character. If this is true, then it is taken to indicate a successful challenge (stage 976). If not, then the challenge is assumed to be a failed one (stage 968). This may indicate that neither the challenging user nor the user asserting ownership really owns the character. In this event, a possible system response is to notify both parties and perhaps offer the key holder the opportunity to formally assert ownership. If the challenge is determined to be successful, then the system response is to set the task as completed in the queue (stage 978). This stage is followed by a release of the original assertion of ownership, as indicated at stage 980. At stage 982, the original claimant to the character is notified. At stage 984, the system may offer the user with the key the chance to rate the community member who sent it in. At stage 986 the system may offer the user the chance to assert ownership of the character themselves. In this situation, this step will lead to a second verification message and key being sent to the user, by a different community member, to complete the verification cycle.

FIG. 9(d) (which in some embodiments corresponds to certain of the functionality of Element 430 of FIG. 4) is a flowchart illustrating an exemplary process 990 for enabling a participant in a verification process to provide feedback and a rating on their experience with the community member involved in the verification process or task. As shown in the figure, at stage 992, the user is offered the opportunity to enter a vote or other comment or data regarding the community participant who was involved in the verification process. If such a vote, comment, or data is provided (stage 994), then a record of that feedback is created or updated (stage 996). The reputation data for the claim verifier is then updated to reflect any votes, etc. (stage 998).

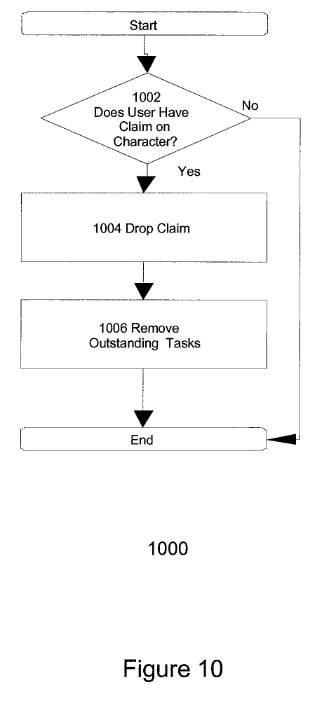

FIG. 10 (which in some embodiments corresponds to certain of the functionality of Element 412 in FIG. 4) is a flowchart illustrating an exemplary process 1000 for enabling a user to release an assertion of ownership in some embodiments of the present invention. As shown in the figure, at stage 1002, the process determines if the user has made a claim of ownership to a character. If so, then the process removes the record of that assertion from the system (stage 1004), and ensures that any outstanding tasks in the verification queue related to that assertion are also removed (stage 1006).

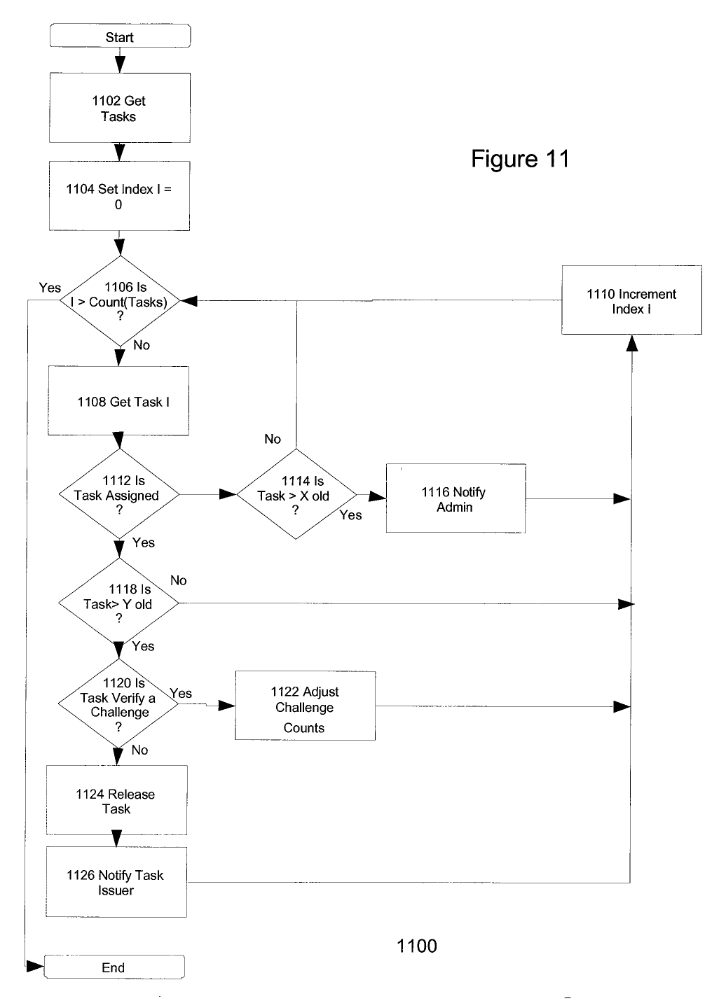

FIG. 11 (which in some embodiments corresponds to certain of the functionality of Element 412 in FIG. 4) is a flowchart illustrating an exemplary process 1100 for enabling certain housekeeping or cleanup tasks such as removing verification tasks that do not seem to be successfully executing from the queue in some embodiments of the present invention. As shown in the figure, stages 1102-1110 implement an iterative loop to walk through all the tasks in the queue. At stage 1112 the process determines if a task has been assigned. If it has not, then at stage 1114, the process determines if the task has been queued for longer than some maximum period X. If it has, then an error condition has occurred, and in one embodiment a notification is sent to a system administrator (stage 1116).

At stage 1118, the process determines if an assigned task has been assigned for longer than some time period Y. If so, the task may be tested to determine if it is still capable of execution, and if so, may be considered live and left in the system. If the task has expired or is not capable of execution, then at stage 1120 the process determines if the task is one of the optional challenge tasks. In this case at stage 1122, the process removes the task from the queue and adjusts any records that are tracking the challenging user's number of challenges. At stage 1124, the process releases the task from the queue and at stage 1126 the process notifies the user asserting ownership. In that case, the user may choose to reassert ownership, or concede the failure of the process.

FIG. 12 is a functional block diagram (which in some embodiments corresponds to certain of the functionality of Element 312 (Cluster Manager) of FIG. 3) illustrating the key components of an Identity Cluster system 1200 in some embodiments of the present invention. An Identity Cluster is a group of identities gathered from a variety of Proprietary Worlds with an anonymous relationship to the user behind them. A trusted Identity Cluster is a group of identities gathered from a variety of Proprietary Worlds with an anonymous but trusted relationship to the user behind them. A real world person participating in one or more proprietary environments may have created or claimed multiple proprietary world identities and may have reasons for selecting a specific identity to represent them in a particular interaction. The Identity Cluster described with reference to FIG. 3 and FIG. 12 provides a method of managing such multiple identities, including selecting the desired identity for a particular interaction.

Element 1202 represents a function, process or service that enables a new participant to the system to register their real world identity. In a typical implementation, the process would involve entry of a name, a password, and an email address. This enables the new participant to be uniquely identified to the system. The act of registration creates an Identity Cluster for the participant. As an alternative, the system may allow a participant to create multiple Identity Clusters. Element 1204 represents a function, process or service that implements a data store where the registration information and all required or desired information may be stored. It may be made up of one or more individual data storage modules.

Element 1206 represents a function, process or service that enables the participant to create a new identity to represent the Proprietary World identity. Typically, the new identity will have the same name as the Proprietary World identity. The Proprietary World in which the identity is to be found would typically be specified, as well as the particular instance, if there are more than one instances of the Proprietary World in existence. This information will provide a unique handle for the identity which may be used by the system or the interface to the system to refer to the identity. Alternatively, a different handle might be generated by the system or the user to refer to the identity, although an implementation of the invention may wish to make the relationship between this handle and the [<Proprietary World, Instance, Identity>] tuple available to the users. Note that a participant may also release an identity that is no longer owned, or no longer relevant to the interactions they desire to be part of.

Element 1208 represents a function, process or service that allows a participant to select an identity (or assert a claim to that identity) from data existing in the system. In some embodiments, the data may have been generated as some form of census analysis of the Proprietary World(s) and their respective characters or avatars. Element 1210 represents a function, process or service that implements such a census gathering process.

Element 1212 represents a function, process or service that enables the relationship between a participant and a Proprietary World identity to be verified. In some embodiments, the Community Verification system described with reference to FIG. 4 (and elsewhere) is an implementation of such functionality, process or system. Note that in some embodiments, a verification process or system may not be required for the functioning of the overall system; however, it may be desirable if the system is intended to assert that the relationship is more trustworthy than one based on just the participant's own assertions.

Element 1214 represents a function, process or service that enables a participant to enter properties associated with their Proprietary World identity. Alternatively, if the census option or other data gathering function has been implemented, these properties may be obtained from the census data. Another possible implementation is to have other participants set or verify these properties.

Element 1216 represents a function, process or service that enables a participant to indicate to the system if the existence of the relationship between a particular Proprietary World identity and other Proprietary World identities in the participant's identity cluster is to be made public or not.

Element 1218 represents a function, process or service that enables other participants in the system to affect various aspects of the reputation of a Proprietary World identity. Typical implementations would allow voting for or against the identity or an attribute of the identity, or rating the identity on some scale.

Element 1220 represents a function, process or service that generates an address for the Proprietary World identity. A typical implementation would use the handle or other generated by Element 1206 as the basis of the address. The address enables a number of functions (such as communications or messaging) to be set up with this identity. When implemented, the participant will be able to participate in communications and other activities as this identity. Element 1222 represents a function, process or service that enables the participant to select which identity in their cluster they will use for a particular activity or interaction.

As discussed previously with regards to FIG. 3, the inventors have recognized that it may be valuable or important to the owner of an identity to associate more information about a Proprietary World identity with that identity than just the name and location of the identity. Such data may include attributes that describe the identity (such as race, or class), attributes that reflect completing challenges (such as quests, or races), attributes that describe group affiliations, attributes that can be used to measure achievement levels or participation, and other relevant characteristics.

However, permitting the owner of an identity to associate such data attributes with the identity without providing a means for verifying the authenticity of those attributes may result in misleading other participants in the proprietary environment. As a result, in order to enable other participants in a proprietary environment to have a sufficient degree of confidence in attributes which an identity owner associates with their proprietary world identity, the inventors have developed a concept, termed “peer verified metadata”, that may be used to provide this capability. Here the term “metadata” is meant to include, but not be limited to, a statistic or attribute, and meant to include attributes inherent in a character (such as its race or class), attributes which are earned by the participant's activity (such as achievement level), attributes that the participant creates themselves, events that the participant attends, groups that the participant is affiliated with, and other aspects of their participation in the proprietary environment that the participant chooses to use the attributes or metadata for. The term “peer verified” refers to the fact that all or some of the metadata may be voted on or verified by other community members. A compilation and/or analysis of the votes may be used to provide a measure of confidence that the Proprietary World identity has or has achieved the attribute in question.

FIG. 13 is a functional block diagram illustrating the key components of an implementation of a peer verified metadata function 1300 in some embodiments of the present invention. Note that further details regarding an embodiment or embodiments of a peer verified metadata system that is suitable for use with the present invention may be found in U.S. Provisional Patent Application No. 60/982,370 entitled “System, Apparatus And Method To Enable Peer Verified Metadata For Use In Interactions Between Real World And Proprietary Environments”, the entire contents of which is incorporated by reference. As shown in the figure, element 1302 represents a function, process or service that enables a user to register with the system, and also acts to identify that user's Proprietary World identity(s) to the system.

In FIG. 13, Element 1304 represents a structure, function, process or service that provides a data storage or database to store the information about the identities and the attributes that a user records. Element 1306 represents a function, process or service that enables the user to create or record an attribute in the system. A desirable implementation enables the user to specify the name and value of the attribute, with no constraints either in terms of data type or format.

Note that an alternative implementation might specify or enforce a taxonomy on names, and possibly a typing of values. An alternative implementation would be to enable users to optionally select attribute names and/or values from lists of attributes/values that have already been entered by other users. A recommended naming scheme is for users to be encouraged to specify complex stats using some kind of separator. For example: “skill.blacksmithing.trophy”, thus building an informal taxonomy into the system.

Element 1308 represents a function, process or service that enables the user to drop an attribute. The feature allows the user to drop or otherwise disassociate an attribute with an identity for any reason. This also enables the user to essentially modify an attribute by dropping an attribute and creating a new attribute with the same name. However, typically, any votes associated with that attribute would be dropped at this point. An alternative implementation would be to also enable an attribute to be modified, but the system operator would need to decide what that would mean in terms of recognizing existing votes.

Element 1 310 represents a function, process or service that enables other users to view or list the set of attributes for an identity. If any of the attributes have been voted on, then the system can also report a degree of confidence in the attribute. If there are no votes, the system might report zero confidence. It is worth noting that not all attributes are considered of sufficient value to be voted on by other participants. Therefore the system cannot make a judgment about an attribute having zero votes as being either true or false. Element 1312 represents a function, process or service that enables a participant to vote on a particular attribute. Typically a high vote would reflect a agreement with the validity of that attribute, and a low vote would reflect disagreement.

In some embodiments, the system allows positive and negative votes on an attribute. Thus another participant may assert that they definitely consider the attribute to be valid, or definitely consider the attribute to be invalid. An alternative implementation which only used positive values (for example the 1-5 star rating system common for book and movie reviews) would essentially be only allowing a user to assert they were minimally confident that an attribute was correct. There are many other types of voting possible, all of which record some measure of a user's agreement with the assertion represented by the attribute without changing the underlying concepts of this invention. For example, an optional implementation may enable certain attributes to be marked as public or private. Private may be taken to mean viewable only by the owner, thus forming a sort of record keeping, or only viewable by participants selected by the owner.

Element 1314 represents a function, process or service that provides a mechanism to search over attributes. Several forms of search may be implemented, including, but not limited to:
Searching for all identities with attributes with a particular name;
Searching for all identities with attributes with a particular value;
A combination of the above;
Restrictions on the search to particular worlds, or other combinations of attributes; and
Searching for all the attributes associated with a particular character.

Note that such a mechanism can be used by participants to identify groups they are affiliated with and thus generate membership lists for forms of social networking. The system may optionally provide mechanisms to assist with such grouping. For example, a “joingroup” command may be a more intuitive way for a user to specify membership than a “create attribute” command.

Element 1316 represents a function, process or service that provides a mechanism to establish confidence in a particular attribute. Such a measure may be calculated on the fly when a user requests a view of an attribute, or at some designated time, particularly if the calculation is intensive in its use of system resources. A variety of calculations or measures may be used without departing form the underling concept of the invention.

Element 1318 represents a function, process or service that enables a collection of attributes from data collected by census style systems, which may interrogate Proprietary Worlds using a variety of mechanisms, or other data sources. While the data is not generally verifiable or complete as noted above, it may be a useful way to drive the user experience.

Element 1320 represents a function, process or service that enables a reward system that a user (or the system) may choose to deploy to encourage other participants to vote on any or particular attributes. Possible rewards include, but are not limited to, recording the number of votes a user has made, money, some Proprietary World item, or some other commodity available to the system.

A system and related architecture, apparatus and methods for enabling an identity management and verification function or process for participants in activities occurring in proprietary environments has been described. The inventive system enables a participant in a gaming, virtual, or other form of proprietary environment to manage the proprietary environment identities and attributes of those identities as they desire while retaining desirable aspects of their participation in the environments. The inventive system also provides a verification function that can verify or confirm the association between a proprietary world identity and a real world identity, thereby increasing the level of trust that can be associated with a proprietary world identity. Further, the invention provides a community based attribute verification system that can be used to enable a form of transportable reputation between the real world and one or more proprietary worlds. In providing these features or functions, the invention enables or facilitates interactions between the real world and one or more proprietary environments, where such interactions include communications, commerce transactions, and content exchange.

As an example, the inventive system may be used to verify that a particular real world person is the rightful owner or claimant of a particular proprietary world identity. In some embodiments, this function is implemented using a previously verified proprietary world identity of a second real world person and a set of identity verification data. The verification data may take the form of a key, data string, or other suitable data. In operation, a first real world person (user 1) registers with the inventive system and asserts that they own an identity in a proprietary world (for example, Avatar A). The inventive system generates the security, identity authentication or identity verification key and provides that data to a second real world person (user 2) using the intermediary of that person's identity in the proprietary world (for example, Avatar B). Note that user 2 has previously registered with the inventive system and has established a verified/authenticated ownership or claim to Avatar B in the proprietary world. User 2 then manipulates Avatar B to transmit the key to Avatar A. This transfer of the data may be accomplished by using a proprietary world communications system, for example. User 1 then obtains or otherwise accesses the key or data from Avatar A (for example, by manipulating or otherwise accessing Avatar A). User 1 then enters that key or data into the inventive system. The system then compares the key or data entered by user A to the key or data provided to user 2. If the two sets of keys or data are the same, then the inventive system accepts user 1's assertion of ownership of Avatar A.

As another example, the inventive system may be used to manage a group or proprietary world identities (and any related data such as preferences, credit card data, etc.) for a particular real world user. In this example, real world person user 1 accesses the inventive system and creates Identity Cluster A which is associated with that person. Identity Cluster A is then populated by that person with one or more Avatars, the ownership of which the inventive system verifies. When user 1 desires to participate in an interaction, user 1 selects the avatar most appropriate to the world in question, say Avatar A, to represent them in the proprietary world. However, the inventive system will have access to and utilize (where appropriate) data associated with Cluster A—for example, a credit card or bank account associated with Cluster A—as needed in the interaction. In this example, a second user interacting through their own Avatar with Avatar A will be able to have the confidence that they are interacting with a verified and trustworthy user, while user 1 will be able to interact and conduct transactions within the proprietary world without disclosing their real world identity or information.

The present invention has been described in terms of specific embodiments. As will be understood by those skilled in the art, the embodiments illustrated above may be modified, altered, and changed without departing from the scope of the present invention. The scope of the present invention is defined by the appended claims.

What is claimed is:

1. An apparatus to verify that a first participant in a proprietary environment is the owner of a proprietary world identity, comprising;
a data storage medium including a set of instructions;
a processing element configured to execute the set of instructions, which when executed cause the processing element to implement processes that include
enabling selection of the proprietary world identity by the first participant in the proprietary environment;
generating first identity verification data;
storing the first identity verification data;
providing the first identity verification data to a second participant in the proprietary environment;
receiving second identity verification data from the first participant in the proprietary environment;
comparing the first identity verification data to the second identity verification data; and
verifying ownership of the proprietary world identity selected by the first participant if the first identity verification data and the second identity verification data are substantially equivalent.

2. The apparatus of claim 1, further comprising instructions which when executed cause the processing element to implement a process to enable the first participant in the proprietary environment to create the proprietary world identity.

3. The apparatus of claim 1, further comprising instructions which when executed cause the processing element to implement a process to enable the first participant in the proprietary environment to select from a list of proprietary world identities.

4. The apparatus of claim 1, further comprising instructions which when executed cause the processing element to implement a process to select the second participant in the proprietary environment from a set of participants having previously verified identities in the proprietary environment.

5. A method of verifying that a first real world person is an owner of a first proprietary world identity, comprising;
determining a second real world person having a previously verified proprietary world identity;
generating first identity verification data;
providing the first identity verification data to the second real world person;
receiving second identity verification data from the first real world person;
comparing the first identity verification data with the second identity verification data; and
if the first identity verification data and the second identity verification data are substantially equivalent, then verifying that the first real world person is the owner of the first proprietary world identity.

6. The method of claim 5, further comprising:
transferring the first identity verification data from the previously verified proprietary world identity to the first proprietary world identity.

7. The method of claim 6, wherein transferring the first identity verification data from the previously verified proprietary world identity to the first proprietary world identity further comprises:
transferring the first identity verification data using a proprietary world communications system.

8. The method of claim 5, further comprising notifying the second real world person that the first real world person has been verified as the owner of the first proprietary world identity.

9. The method of claim 5, wherein the first identity verification data is one of a security key, data string, or data object.

10. The method of claim 5, wherein determining a second real world person having a previously verified proprietary world identity further comprises:
accessing a data structure containing a list of proprietary world identities and associated verified real world owners of each identity.

11. A method of enabling a first real world person represented by a first proprietary world identity to engage in an interaction with a second real world person represented by a second proprietary world identity, comprising;
registering one or more proprietary world identities associated with the first real world person;
verifying that the first real world person is the owner of each of the one or more proprietary world identities;
presenting the first real world person with a list of the one or more proprietary world identities that the first real world person is the verified owner of;
receiving from the first real world person a selection of one of the one or more verified proprietary world identities; and
utilizing the selected verified proprietary world identity to interact with the second proprietary world identity.

12. The method of claim 11, wherein verifying that the first real world person is the owner of each of the one or more proprietary world identities further comprises, for each proprietary world identity:
determining a third real world person having a previously verified proprietary world identity;
generating first identity verification data;
providing the first identity verification data to the third real world person;
receiving second identity verification data from the first real world person;
comparing the first identity verification data with the second identity verification data; and
if the first identity verification data and the second identity verification data are substantially equivalent, then verifying that the first real world person is the owner of the proprietary world identity.

13. The method of claim 12, further comprising:
transferring the first identity verification data from the previously verified proprietary world identity to the proprietary world identity.

14. The method of claim 13, wherein transferring the first identity verification data from the previously verified proprietary world identity to the proprietary world identity further comprises:
transferring the first identity verification data using a proprietary world communications system.

15. A system to facilitate interactions between a first participant in a proprietary environment and a second participant in a proprietary environment, comprising:
a server in communication with and capable of exchanging data with a first client and a second client, the first client operated by the first participant and the second client operated by the second participant;
a process executing on the server to enable the first participant to select a proprietary environment identity;
a process executing on the server to enable the second participant to select a proprietary environment identity; and
a process executing on the server to enable verification of the ownership of the proprietary world identity selected by the first participant.

16. The system of claim 15, wherein the process executing on the server to enable verification of the ownership of the proprietary environment identity selected by the first participant further comprises:
determining a third participant having a previously verified proprietary environment identity;
generating first identity verification data;
providing the first identity verification data to the third participant;
receiving second identity verification data from the first participant;
comparing the first identity verification data with the second identity verification data; and
if the first identity verification data and the second identity verification data are substantially equivalent, then verifying that the first participant is the owner of the proprietary environment identity selected by the first participant.

17. The system of claim 15, further comprising:
a process executing on the first client to enable communication and exchange of data with the proprietary environment;
a process executing on the second client to enable communication and exchange of data with the proprietary environment; and
a process executing in the proprietary environment to enable communication between the first participant and the second participant.

18. The system of claim 16, wherein receiving second identity verification data from the first participant further comprises:
communicating the first identity verification data from the previously verified proprietary environment identity to the proprietary environment identity selected by the first participant; and
communicating the first identity verification data from the proprietary environment to the first client.
